(19) United States
(12) Patent Application Publication
(10) Pub. No.: US 2024/0253043 A1
(43) Pub. Date: Aug. 1, 2024

(54) SYSTEMS, DEVICES, AND METHODS FOR COMBINING REAGENTS AND FOR HIGH-CONTENT IN-SITU TRANSCRIPTOMICS

(71) Applicant: Hunter BioDiscovery, Inc., Boston, MA (US)

(72) Inventors: Tal Raz, Brookline, MA (US); Xiao Wang, Waltham, MA (US); Boryana Zhelyazkova Pursley, Dedham, MA (US); David Allan Weitz, Bolton, MA (US); Joshua Seth Wachman, Newton, MA (US); Efstathios George Eleftheriadis, Lynn, MA (US); Anthony Robert Soltis, Kensington, MD (US)

(73) Assignee: Hunter BioDiscovery, Inc., Boston, MA (US)

(21) Appl. No.: 18/290,301

(22) PCT Filed: May 22, 2022
(86) PCT No.: PCT/US2022/030445

§ 371 Date: Nov. 12, 2023

Related U.S. Application Data
(60) Provisional application No. 63/193,041, filed on May 25, 2021.
(60) Provisional application No. 63/344,475, filed on May 20, 2022.

(51) Int. Cl. B01L 3/00

(52) U.S. Cl. CPC B01L 3/502784; B01L 3/5085; B01L 2200/027; B01L 2200/0647; B01L 2200/0673; B01L 2200/16; B01L 2300/021; B01L 2300/0829; B01L 2400/0457; B01L 2400/0463; B01L 2400/0469

(57) ABSTRACT

A microfluidic system includes a matrix structure having a plurality of wells, each of the wells being accessible via at least one microfluidic path connectable via an interface to at least one droplet input for receiving one or more sets of droplets from one or more droplet sources, wherein a droplet enters a well based on one or more of: buoyancy, gravity, hydrodynamic force, and/or mechanical capturing, and wherein contents of a particular well are determinable based on a position of the particular well in the matrix structure and on inputs to the matrix structure. Methods using the matrix structure.

### RELATED APPLICATIONS

This application is related to and claims the benefit of U.S. provisional patent application No. 63/193,041, filed May 25, 2021, and U.S. provisional patent application No. 63/344,475, filed May 20, 2022, the entire contents of each which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

Aspects of this invention relate to liquid handling, and, more particularly, to a microfluidic droplet platform for dispensing and combining reagents. Other aspects of the invention relate to high content in situ transcriptomics.

### BACKGROUND

Droplets of one fluid in a continuous phase of another, immiscible fluid, can be chemically stabilized such that the emulsion is collected in a single vessel containing independent individual droplets. Such emulsions have been widely used to compartmentalize a heterogeneous set of materials without mixing with one another while keeping them conveniently collected together. A well-known example is the partitioning of nucleic acids such as cellular RNA, or genomic DNA, into a multitude of droplets enabling a digital quantification of molecules by assessing the number of droplets that contain the nucleic-acid target of interest.

In another example, single cells can be isolated into separate droplets to facilitate transcription profiling of individual cells, and in a third example, antibody molecules can be individually tested in droplets against targets of interest. While the separation of macromolecules such as DNA, proteins, or even whole cells, has been successfully implemented using emulsion technologies, it is not possible to isolate small molecules in emulsions since they can often freely cross between adjacent droplets.

High throughput drug screening is ubiquitously used in drug development. The number of compounds screened ranges from thousands to millions, depending on the stage of drug development and the type of assay utilized. The prospect of using minute volume emulsions for high throughput screening could enable rapid testing of a large number of compounds. However, it would require a method to prevent the crossing over of drugs between droplets.

### SUMMARY

Aspects of the present invention are specified in the claims as well as in the below description. Preferred embodiments are particularly specified in the dependent claims and the description of various embodiments.

One general aspect includes a microfluidic system that includes a matrix structure having a plurality of wells, each of the wells being accessible via at least one microfluidic path connectable via an interface to at least one droplet input for receiving one or more sets of droplets from one or more droplet sources, where a droplet enters a well based on one or more of: buoyancy and/or gravity, and where contents of each well are determinable based on a position of the well in the matrix structure and on inputs to the matrix structure.

Implementations may include one or more of the following features, alone and/or in combination(s):
The microfluidic system where the wells are arranged in m columns and n rows, where m and n are positive integers.
The system where m=n.
The system where m≠n.
The system where m is in the range of 1 to 1,000 and n is in the range of 1 to 1,000.
The system where the columns and/or rows are evenly spaced.
The system where the columns and/or rows are unevenly spaced.
The microfluidic system may include at least one set of loading channels for providing droplets from the droplet sources to the wells.
The system where the at least one set of loading channels is integrated into the matrix structure.
The system where the at least one set of loading channels is integrated into a loading module, sealably connectable to the matrix structure.
The microfluidic system may include two sets of loading channels for providing droplets from the droplet sources to the wells.
The system where the two sets of loading channels are integrated into the matrix structure.
The system where the two sets of loading channels may include: a first set of p loading channels, corresponding to the m columns; and a second set of q loading channels, corresponding to the n rows.
The system where the two sets of loading channels may include: a first set of p loading channels, corresponding to the m columns, where p 32 m; and a second set of q loading channels, corresponding to the n rows, where q=n.
The system where the number of loading channels is different than the number of columns and/or rows.
The system where there are fewer loading channels than columns and/or rows.
The system where droplets from the droplet sources enter the matrix structure via the loading channels.
The system where the one or more droplet sources may include: a first m droplet sources corresponding to the first set of m loading channels; and a second n droplet sources corresponding to the second set of n loading channels.
The system where wells allow controlled releasing of a certain number of droplets from the wells by tilting the matrix structure.
The microfluidic system may include an area where droplets can flow and get access to the wells.
The system where the area may include a plain chamber or a chamber with structures.
The system where the structures may include grooves, channels, and/or posts.
The system where the area may include the at least one microfluidic path.
The system where the one or more droplets rise or sink via buoyancy from the at least one microfluidic path into wells having sufficient space.
The system where the wells are sized to capture and/or hold at least one, at least two, at least three, at least four, at least five, at least six, at least seven, at least eight, at least nine, and/or at least ten droplets.
The system where each of the wells is cylindrical, a cube, cuboid, a dome, triangular, hexagonal, or one or more of these shapes, combined vertically and/or horizontally.
The system where the shape of the wells allows droplets to be released from the wells by flipping or tilting the matrix structure.
The system where the shape of the wells allows release of a selective number of droplets by flipping or tilting the matrix structure.
The system where the one or more droplet sources provide droplets of reagents.
The microfluidic system may include a plurality of droplet generators.
The plurality of droplet generators generates droplets of a volume of at least 1 pl, at least 1 nl, at least 100 nl, at least 1 μl, or at least 10 μl.
At least some of the plurality of droplet generators continuously emulsify reagents of volume of at least 1 pl, at least 1 nl, at least 100 nl, at least 1 μl, at least 10 μl, at least 100 μl, at least 1 ml, at least 10 ml, at least 100 ml, or at least 1 liter.
The system where the plurality of droplet generators is connectable to the matrix structure via tubing.
The system where the droplet generators are integrated into the matrix structure.
The system where the droplet generators work simultaneously as the matrix structure.
The system where the droplet generators emulsify reagents that are stored and are introduced into the matrix structure at a different time.
The system where the one or more sets of droplets may include one or more reagents selected from one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
The system where the one or more sets of droplets comprise one or more drugs selected using a drug synergy prediction model.
The system where the one or more sets of droplets were selected using a drug synergy prediction model that uses machine learning to predict synergy responses from drug combinations.
The system where the drug synergy prediction model uses machine learning to generate hypotheses for follow on experiments.

Another general aspect includes (a) providing first droplets into a plurality of wells via first paths of a matrix structure, and where the first droplets enter the plurality of wells via the first paths by one or more of buoyancy, gravity, hydrodynamic force, and/or mechanical capturing. The method also includes (b) providing second droplets into at least some of the plurality of wells by buoyancy, gravity, and/or guiding structures, where at least some of the plurality of wells contain a combination of a droplet from the first droplets and a droplet from the second droplets. The method also includes where each combination of droplets is spatially identifiable by position in the matrix structure.

Implementations may include one or more of the following features, alone and/or in combination(s):
The method where the first droplets may include emulsified reagents selected from one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials
The method may include: (c) merging each combination of droplets in the wells.
The method where the merging in (c) may include applying an electric field, acoustic wave, heat, mechanical agitation, selective evaporation of continuous phase, or chemical reagents.
The method where the merging in (c) may include washing away a chemical reagent such as washing away a surfactant.
The method where wells are arranged in m rows and n columns, and where the first droplets are provided using m first droplet sources, each arranged to provide droplets to a corresponding row of wells.
The method where second droplets are provided using n second droplet sources, each arranged to provide droplets to a corresponding column of wells.
The method where each of the m first droplet sources provides a first different type of droplet to the corresponding rows, and where each of the n second droplet sources provides a second different type of droplet to the corresponding columns.
The method where the m first droplet sources provide m first different types of droplets, and where the n second droplet sources provide n second different types of droplets.
The method where a particular well at column i, and row j in the matrix, for 1≤i≤m, and 1≤j≤n, contains a particular combination of a first droplet from the i-th first droplet source and a second droplet from the j-the second droplet source.
The method may include, before beginning the providing in (b), continuing the providing in (a) until each well of the matrix structure contains at least one of the first droplets.
The method manipulating the matrix structure to selectively release droplets from the wells.
The method manipulating the matrix structure, if needed, to selectively release droplets from the wells.
The method where the providing in (b) begins after each well of the matrix has one of the first droplets.
The method where at least some of the plurality of wells contain a combination of a droplet from the first droplets and a droplet from the second droplets, and a droplet from the third droplets.
The method where the first droplets may include a first set of drugs and where the second droplets may include a second set of drugs, the method may include: (e) introducing a live cell into each of the wells, where each well contains a combination of a first drug from the first set of drugs, a second drug from the second set of drugs, and a live cell. The first set of drugs is identical to the second set of drugs.
The method where droplets are introduced into the wells in an order (i) drug, drug, cell; or (ii) cell, drug, drug, or (iii) drug, cell, drug.
The method where at least some of the drugs were selected using a drug synergy prediction model.
The method where at least some of the drugs were selected using a drug synergy prediction model that uses machine learning to predict synergy responses from drug combinations.
The method where the drug synergy prediction model uses machine learning to generate hypotheses for follow on experiments.
The method where the providing in (a) uses oil to connect the wells.
The method may include replacing the oil with air or some other gas.
The method may include quantifying the effect of the combinations of drugs in the wells.
The method where the quantification uses imaging of the wells.
The method may include selectively retrieving content from wells of interest after imaging.

Another general aspect includes (a) providing a plate that includes a matrix structure having a plurality of wells, each of the wells being accessible via at least one microfluidic path connectable via an interface to at least one droplet input for receiving one or more sets of droplets from one or more droplet sources, where the wells are arranged in m columns and n rows, where m and n are positive integers. The method also includes (b) populating each particular well of at least some of the wells with a droplet may include well-location information to determine a location of the well in the matrix structure.

Implementations may include one or more of the following features, alone and/or in combination(s):
The method where the well-location information in the droplet for a given well may include (i) a column oligo barcode that identifies which column of the matrix structure the given well is in; and (ii) a row oligo barcode that identifies which row of the matrix structure the given well is in.
The method where the populating in (b) may include: (b)(1) populating wells in the matrix structure with column droplets may include column oligo barcodes that identify which column of the matrix structure a well is in; and (b)(2) populating wells in the matrix structure with row droplets row oligo barcodes that identify which row of the matrix structure a well is in.
The populating in (b) further may include: (b)(3) populating wells in the matrix structure with reagent droplets may include at least one reagent.
The reagent(s) may include one or more of buffers, enzymes, oligonucleotides, dyes, dNTPs, reverse transcriptase, and/or antibodies.
The method may include, in wells containing a column droplet, a row droplet, and a reagent droplet, merging the column droplet and the row droplet and the reagent droplet to form the droplet may include well-location information.
The method where the at least one reagent is selected from one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
The method may include sealing the matrix structure.
The method may include freezing the matrix structure.
The method where m is 1 to 1,000 and n is 1 to 1,000, for instance, m is 100 and n is 100.
The method where the matrix structure is p mm×q mm, where p is in the range 1 to 100 and q is in the range 1 to 100.
The matrix structure has a well density of about 1 well per 100 μm² to 1 well per mm².
The columns are evenly spaced, and the rows are evenly spaced.
A plate formed by the method(s) above.

Another general aspect includes a plate having a matrix structure having a plurality of wells, each of the wells being accessible via at least one microfluidic path connectable via an interface to at least one droplet input for receiving one or more sets of droplets from one or more droplet sources, where the wells are arranged in m columns and n rows, where m and n are positive integers. The plate also includes where each particular well of at least some of the wells is populated with a droplet may include well-location information to determine a location of the well in the matrix structure.

Implementations may include one or more of the following features, alone and/or in combination(s):
The plate where the well-location information in the droplet for a given well may include (i) a column oligo barcode that identifies which column of the matrix structure the given well is in; and (ii) a row oligo barcode that identifies which row of the matrix structure the given well is in.
The plate where the droplets in the wells in the matrix structure also may include at least one reagent.
The at least one reagent may include one or more of: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
The plate has a well density of about 1 well per 100 um² to 1 well per mm².
The plate is about p mm×q mm, where p is in the range 1 to 100 and q is in the range 1 to 100.
The plate has between 10 and 10,000 wells, more preferably between 500 and 5,000 wells.
The plate where the well diameter of a well is about 10 microns, to about 100 microns, preferably about 10 microns.
The plate wherein the wells are each about 10 microns in diameter.

Another general aspect includes (a) pressing a matrix plate against a tissue specimen on a slide, where the matrix plate may include a plurality of wells, each populated with a droplet may include well-location information to determine a location of the well in the matrix plate, wherein the pressing causes at least one reagent from each of the wells to come in contact with the tissue specimen. The method also includes combining the content of the matrix well with the tissue specimen. The method also includes (b) imaging the matrix plate pressed against the tissue specimen. The method also includes (c) collecting content from the wells. The method also includes (d) sequencing the collected content. The method also includes (e) using the sequenced collected content to provide an RNA profile of the tissue specimen by location.

Implementations may include one or more of the following features, alone and/or in combination(s):
The method where the method includes, before the collecting in (c), combining the contents of the wells with the tissue specimen.
The method where the combining includes centrifuging the matrix plate pressed against the tissue specimen; and then flipping the matrix plate, and then again centrifuging the matrix plate pressed against the tissue specimen.
The method where the matrix plate is clamped to the slide.
The method where the at least one reagent includes one or more of: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
The method where, prior to the collecting in (C), the at least one reagent from at least some of the wells comes in contact with and then binds to proteins and/or RNA and/or DNA in the tissue specimen.
The method where reagents from at least some of the wells come into contact with the tissue specimen and trigger enzymatic reactions.
The method where the enzymatic reactions comprise reverse transcription of the RNA and/or copying of DNA.
The method where proteins or nucleic acids (such as RNA or DNA) from the tissue specimen are collected into the wells.
The method where enzymatic reactions between the proteins or nucleic acids from the tissue specimen and the at least one reagent occur in at least some of the wells.
The method where chemical reactions occur in the wells between the tissue specimen in the wells and content of the wells.
The method where the chemical reactions comprise reverse transcription of tissue specimen's RNA; and/or PCR amplification of the tissue specimen's DNA; and/or binding of antibodies to proteins of the tissue specimen.

Below is a list of embodiments, including system embodiments, process embodiments, and plate (device) embodiments. System embodiments will be indicated with the letter “S.” Whenever such embodiments are referred to, this will be done by referring to “S” embodiments. Process embodiments will be indicated with the letter “P.” Whenever such embodiments are referred to, this will be done by referring to “P” embodiments. Plate (device) embodiments will be indicated with the letter “D.” Whenever such embodiments are referred to, this will be done by referring to “D” embodiments.
S1. A microfluidic system comprising:
   a matrix structure having a plurality of wells,
   each of the wells being accessible via at least one microfluidic path connectable via an interface to at least one droplet input for receiving one or more sets of droplets from one or more droplet sources,
   wherein a droplet enters a well based on one or more of buoyancy, gravity, hydrodynamic force, and/or mechanical capturing, and
   wherein contents of a particular well are determinable based on a position of the particular well in the matrix structure and on inputs to the matrix structure.
S2. The microfluidic system of system embodiment S1, wherein the wells are arranged in m columns and n rows, where m and n are positive integers.
S3. The microfluidic system of system embodiment S2, wherein m=n.
S4. The microfluidic system of system embodiment S2, wherein m≠n.
S5. The microfluidic system of any of system embodiment(s) S2-S4, wherein m is 1 to 1,000 and n is 1 to 1,000.
S6. The microfluidic system of any of system embodiment(s) S2-S5, wherein the columns are evenly spaced and/or the rows are evenly spaced.
S7. The microfluidic system of any of system embodiment(s) S2-S6, wherein the columns and/or rows are unevenly spaced.
S8. The microfluidic system of any of the system embodiments, wherein wells allow controlled releasing of a certain number of droplets from the wells by tilting the matrix structure.
S9. The microfluidic system of any of the system embodiments further comprising an area where droplets can flow and get access to the wells.
S10. The microfluidic system of system embodiment(s) S9, wherein the area comprises a plain chamber or a chamber with one or more structures.
S11. The microfluidic system of system embodiment(s) S10, wherein the one or more structures comprise grooves, channels, and/or posts.
S12. The microfluidic system of any of the system embodiment(s) S9-S11, wherein the area comprises the at least one microfluidic path.
S13. The microfluidic system of any of the system embodiments, wherein one or more droplets rise or sink via buoyancy from the at least one microfluidic path into wells having sufficient space.
S14. The microfluidic system of any of the system embodiments, wherein the wells are sized to capture and/or hold at least one, at least two, at least three, at least four, at least five, at least six, at least seven, at least eight, at least nine, and/or at least ten droplets.
S15. The microfluidic system of any of the system embodiments, wherein each of the wells is cylindrical, a cube, cuboid, a dome, triangular, hexagonal, or one or more of these shapes, combined vertically and/or horizontally.
S16. The microfluidic system of any of the system embodiments, wherein a shape/the shapes of the wells allows droplets to be released from the wells by flipping or tilting the matrix structure.
S17. The microfluidic system of any of the system embodiments, wherein a shape/the shapes of the wells allows release of a selective number of droplets by flipping or tilting the matrix structure.
S18. The microfluidic system of any of the system embodiments comprising at least one set of loading channels for providing droplets from the droplet sources to the wells.
S19. The microfluidic system of system embodiment S18, wherein the at least one set of loading channels is integrated into the matrix structure.
S20. The microfluidic system of system embodiment(s) S18-S19, wherein the at least one set of loading channels is integrated into a loading module, sealably connectable to the matrix structure.
S21. The microfluidic system of any of the system embodiments comprising two sets of loading channels for providing droplets from the droplet sources to the wells.
S22. The microfluidic system of system embodiment S21, wherein the two sets of loading channels are integrated into the matrix structure.
S23. The microfluidic system of any of the system embodiment(s) S21-S22, wherein the two sets of loading channels comprise:
   a first set of p loading channels for the columns; and
   a second set q of loading channels for the rows.
S24. The microfluidic system of any of the system embodiment(s) S21-S23, wherein there are m columns and m loading channels for the columns.
S25. The microfluidic system of any of the system embodiment(s) S21-S24, wherein there are n rows and n loading channels for the rows.
S26. The microfluidic system of any of the system embodiment(s) S22-S25, wherein there is a loading channel for each column.
S27. The microfluidic system of system embodiment(s) S25-S26, wherein there is a loading channel for each row.
S28. The microfluidic system of system embodiment(s) S23-S27, wherein droplets from the droplet sources enter the matrix structure via the loading channels.
S29. The microfluidic system of system embodiment(s) S23-S28, wherein the one or more droplet sources comprise:
   a first m droplet sources corresponding to the first set of p loading channels; and
   a second n droplet sources corresponding to the second set of q loading channels.
S30. The microfluidic system of any of the system embodiments, wherein the one or more droplet sources provide droplets of reagents.
S31. The microfluidic system of any of the system embodiments further comprising a plurality of droplet generators.
S32. The microfluidic system of system embodiment(s) S31, wherein the droplet generators generate droplets of volume of at least 1 pL, or at least 1 nL, or at least 100 nL, or at least 1 μL, or at least 10 μL.
S33. The microfluidic system of any of the system embodiment(s) S31-S32, wherein at least some of the droplet generators generate continuously emulsifying reagents of volume of at least 1 pL, or at least 1 nL, or at least 100 nL, or at least 1 μL, or at least 10 μL, or at least 100 μL, or at least 1 mL, or at least 10 mL, or at least 100 mL, or at least 1 L.
S34. The microfluidic system of any of the system embodiment(s) S31-S33, wherein the droplet generators are connectable to the matrix structure via tubing.
S35. The microfluidic system of any of the system embodiment(s) S31-S34, wherein the droplet generators are integrated into or with the matrix structure.
S36. The microfluidic system of any of the system embodiment(s) S31-S35, wherein the droplet generators operate simultaneously as the matrix structure.
S37. The microfluidic system of any of the system embodiment(s) S31-S36, wherein the droplet generators emulsify reagents that are stored and are re-introduced into a matrix structure at a different time.
S38. The microfluidic system of system embodiment(s) S37, wherein emulsified reagents are stored in one or more containers.
S39. The microfluidic system of system embodiment(s) S38, wherein the one or more containers comprise one or more: tubing, tubes, a multiwell plate, and/or a matrix plate, alone or in combination.
S40. The microfluidic system of any of the system embodiments, wherein the one or more sets of droplets comprise one or more reagents selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
S40-1. The microfluidic system of any of the system embodiments, wherein the one or more sets of droplets comprise one or more drugs, and wherein the one or more drugs were selected using a drug synergy prediction model.
S40-2. The microfluidic system of system embodiment(s) S40-1, wherein the drug synergy prediction model uses machine learning to predict synergy responses from drug combinations.
S40-3. The microfluidic system of any of the system embodiment(s), wherein at least some of the drugs were selected using a drug synergy prediction model that uses machine learning to predict synergy responses from drug combinations.
S40-4. The microfluidic system of any of the system embodiment(s), wherein the drug synergy prediction model uses machine learning to generate hypotheses for follow on experiments.
P41. A method comprising:
   (A) providing first droplets into a plurality of wells via one or more paths of a matrix structure, and wherein the first droplets enter the plurality of wells via the one or more paths by buoyancy, gravity, hydrodynamic force, and/or mechanical capturing; and
   (B) providing second droplets into at least some of the plurality of wells, by buoyancy, gravity, hydrodynamic force, and/or mechanical capturing, wherein at least some of the wells contain a combination of a droplet from the first droplets and a droplet from the second droplets, wherein each combination of droplets is spatially identifiable by position in the matrix structure.
P42. The method of process embodiment P41, wherein the first droplets comprise emulsified reagents selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
P42-1. The method of process embodiment P42, wherein the first droplets comprise one or more drugs, and wherein the one or more drugs were selected using a drug synergy prediction model.
P42-2. The method of process embodiment P42-1, wherein the drug synergy prediction model uses machine learning to predict synergy responses from drug combinations.
P42-3. The method of process embodiments P42-1 or P42-2, wherein the drug synergy prediction model uses machine learning to generate hypotheses for follow on experiments.
P43. The method of process embodiment(s) P41-P42, further comprising (C) merging each combination of droplets in the wells.
P44. The method of process embodiment(s) P43, wherein the merging in (C) comprises applying an electric field, acoustic wave, heat, mechanical force, or chemical reagents.
P45. The method of any of the process embodiment(s) P41-P44, wherein one or more additional droplets comprising reagents are added into at least some of the plurality of wells prior to the merging in (C).
P46. The method of any of the process embodiment(s) P41-P45, wherein the one or more additional droplets comprise emulsified reagents selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
P46-1. The method of any of the process embodiments P46, wherein the one or more additional droplets comprise one or more drugs selected using a drug synergy prediction model.
P46-2. The method of any of the process embodiments P46-1, wherein the drug synergy prediction model uses machine learning to predict synergy responses from drug combinations.
P46-3. The method of any of the process embodiments P46-1 or P46-2, wherein the drug synergy prediction model uses machine learning to generate hypotheses for follow on experiments.
P47. The method of any of the process embodiment(s) P41-P46, wherein the wells are arranged in rows and columns, and wherein the one or more paths comprise one or more channels aligned with the columns.
P48. The method of any of the process embodiment(s) P41-P47, wherein there is one channel per column.
P49. The method of any of the process embodiment(s) P47-P48, wherein there are n columns, and wherein the one or more paths comprise n paths.
P50. The method of any of the process embodiment(s) P41-P49, wherein the one or more paths comprise one or more common reservoirs being fed into the columns.
P51. The method of process embodiment(s) P50, wherein the one or more common reservoirs consist of a single reservoir.
P52. The method of any of the process embodiment(s) P41-P51, wherein the wells are arranged in m rows and n columns, and wherein the first droplets are provided using m first droplet sources, each arranged to provide droplets to a corresponding row of wells.
P53. The method of any of the process embodiment(s) P41-P52, wherein the second droplets are provided using n second droplet sources, each arranged to provide droplets to a corresponding column of wells.
P54. The method of any of the process embodiment(s) P52-P53, wherein each of the m first droplet sources provides a first different type of droplet to the corresponding rows, and wherein each of the n second droplet sources provides a second different type of droplet to the corresponding columns.
P55. The method of any of the process embodiment(s) P52-P54, wherein the m first droplet sources provide m first distinct types of droplets, and wherein the n second droplet sources provide n second distinct types of droplets.
P56. The method of any of the process embodiment(s) P41-P55, wherein a particular well at column i and row j in the matrix, for 1≤i≤m, and 1≤j≤n, contains a particular combination of a first droplet from the i-th first droplet source and a second droplet from the j-th second droplet source.
P57. The method of any of the process embodiment(s) P41-P56, further comprising, before beginning the providing in (B), continuing the providing in (A) until each well of the matrix structure contains at least one of the first droplets.
P58. The method of any of the process embodiment(s) P41-P57, manipulating the matrix structure to selectively release droplets from the wells.
P58-1. The method of any of the process embodiment(s) P41-P57, manipulating the matrix structure, if needed, to selectively release droplets from the wells.
P59. The method of any of the process embodiment(s) P41-P58, wherein the providing in (B) begins after each well of the matrix structure has one of the first droplets.
P60. The method of any of the process embodiment(s) P41-P59, further comprising: (D) providing third droplets into at least some of the plurality of wells by buoyancy, gravity, hydrodynamic force, and/or mechanical capturing, wherein at least some of the wells contain a combination of a droplet from the first droplets and a droplet from the second droplets and a droplet from the third droplets.
P61. The method of any of the process embodiment(s) P41-P60, wherein the first droplets comprise a first set of drugs and wherein the second droplets comprise a second set of drugs, the method further comprising (E) introducing a live cell into each of the wells, wherein each well contains a combination of a first drug from the first set of drugs, a second drug from the second set of drugs, and a live cell.
P62. The method of process embodiment(s) P61, wherein the first set of drugs is identical to the second set of drugs.
P63. The method of process embodiment(s) P61-P62, where droplets are introduced into the wells in an order (i) drug, drug, cell; or (ii) cell, drug, drug, or (iii) drug, cell, drug.
P63-1. The method of process embodiment(s) P61, wherein at least some of the first set of drugs and at least some of the second set of drugs were selected using a drug synergy prediction model.
P63-2. The method of process embodiment(s) P63-1, wherein the drug synergy prediction model uses machine learning to predict synergy responses from drug combinations.
P63-3. The method of any of the process embodiment(s), wherein at least some of the drugs were selected using a drug synergy prediction model that uses machine learning to predict synergy responses from drug combinations.
P63-4. The method of any of the process embodiments P63-1 to P63-3, wherein the drug synergy prediction model uses machine learning to generate hypotheses for follow on experiments.
P64. The method of any of the process embodiment(s) P41-P63, wherein the providing in (A) uses oil to connect the wells.
P65. The method of embodiment(s) P64, further comprising replacing the oil with air or some other gas.
P66. The method of any of the process embodiment(s) P41-P65, further comprising quantifying an effect of combinations of drugs in the wells.
P67. The method of process embodiment(s) P66, wherein the quantifying uses imaging of the wells.
P68. The method of process embodiment(s) P67, further comprising selectively retrieving content from wells of interest after imaging.
P69. A method comprising:
   (A) providing a plate comprising a matrix structure having a plurality of wells, each of the wells being accessible via at least one microfluidic path connectable via an interface to at least one droplet input for receiving one or more sets of droplets from one or more droplet sources, wherein the wells are arranged in m columns and n rows, where m and n are positive integers; and
   (B) populating each particular well of at least some of the wells with a droplet comprising well-location information to determine a location of the well in the matrix structure.
P70. The method of process embodiment(s) P69, wherein the well-location information in the droplet for a given well comprises (i) a column oligo barcode that identifies which column of the matrix structure the given well is in; and (ii) a row oligo barcode that identifies which row of the matrix structure the given well is in.
P71. The method of process embodiment(s) P69-P70, wherein the populating in (B) comprises:
   (B)(1) populating wells in the matrix structure with column droplets comprising column oligo barcodes that identify which column of the matrix structure a well is in; and
   (B)(2) populating wells in the matrix structure with row droplets row oligo barcodes that identify which row of the matrix structure a well is in.
P72. The method of process embodiment(s) P71, wherein the populating in (B) further comprises (B)(3) populating wells in the matrix structure with reagent droplets comprising at least one reagent.
P73. The method of process embodiment(s) P72, further comprising, in wells containing a column droplet, a row droplet, and a reagent droplet, merging the column droplet and the row droplet and the reagent droplet to form the droplet comprising well-location information.
P73-1. The method of process embodiment(s) P72-P73, wherein the reagent droplets comprise one or more reagents selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.
P74. The method of any of the process embodiment(s) P69 - P73-1, further comprising sealing the matrix structure.
P75. The method of any of the process embodiment(s) P69-P74, further comprising freezing the matrix structure.
P76. The method of any of the process embodiment(s) P69-P75, wherein m is 1 to 1,000 and nis 1 to 1,000.
P77. The method of any of the process embodiment(s) P69-P76, where the matrix structure is about p mm×q mm, where p is in the range 1 to 100 and q is in the range 1 to 100.
P78. The method of any of the process embodiment(s) P69-P77 wherein the matrix structure has a well density of about one well per 100 μm² to one well per mm².
P79. The method of any of the process embodiment(s) P69-P78, wherein the matrix structure has a well density of about 1000/mm² or about 100/mm² or about 10/mm².
P80. The method of any of the process embodiment(s) P69-P79, wherein the columns are evenly spaced, and the rows are evenly spaced.
P80-1. The method of any of the process embodiment(s) P69-P80, wherein the at least one reagent is selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials
D81. A plate comprising:
   a matrix structure having a plurality of wells, each of the wells being accessible via at least one microfluidic path connectable via an interface to at least one droplet input for receiving one or more sets of droplets from one or more droplet sources, wherein the wells are arranged in m columns and n rows, where m and n are positive integers,
   wherein each particular well of at least some of the wells is populated with a droplet comprising well-location information to determine a location of the well in the matrix structure.
D82. The plate of any of the plate embodiments, wherein the well-location information in the droplet for a given well comprises (i) a column oligo barcode that identifies which column of the matrix structure the given well is in; and (ii) a row oligo barcode that identifies which row of the matrix structure the given well is in.
D83. The plate of any of the plate embodiments, where the droplets in the wells in the matrix structure also comprise at least one reagent.
D84. The plate of any of the plate embodiments, wherein the at least one reagent is selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials
D85. The plate of any of the plate embodiments, wherein the plate has a well density of about one well per 100 um² to one well per mm².
D86. The plate of any of the plate embodiments, wherein the plate is about p mm×q mm, where p is in the range 1 to 100 and q is in the range 1 to 100.
D87. The plate of any of the plate embodiments, wherein the plate has between 10 and 10,000 wells, more preferably between 500 and 5000 wells.
D88. The plate of any of the plate embodiments, wherein a well diameter of a well is about 10 microns, to about 100 microns, preferably about 10 microns.
D89. A plate formed by the method of any of the method embodiments.
P90. A method comprising:
   (A) pressing a matrix plate against a tissue specimen on a slide, wherein the matrix plate comprises a plurality of wells, each populated with a droplet comprising well-location information to determine a location of the well in the matrix plate, wherein said pressing causes at least one reagent from each of the wells to come in contact with the tissue specimen;
   (B) imaging the matrix plate pressed against the tissue specimen;
   (C) collecting content from the wells;
   (D) sequencing the collected content; and
   (E) using the sequenced collected content to provide an RNA profile of the tissue specimen by location.
P91. The method of process embodiment P90, further comprising, before the collecting in (C), combining the contents of the wells with the tissue specimen.
P92. The method of process embodiment(s) P91, wherein the combining comprises:
   centrifuging the matrix plate pressed against the tissue specimen; and then flipping the matrix plate and then again centrifuging the matrix plate pressed against the tissue specimen.
P93. The method of process embodiment(s) P90 wherein the matrix plate is clamped to the slide.
P94. The method of any of the process embodiment(s) P90-P93, wherein the at least one reagent is selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials
P95. The method of any of the process embodiment(s) P90-P94, wherein, prior to said collecting in (C), the at least one reagent from at least some of the wells comes in contact with and then binds to proteins and/or RNA and/or DNA in the tissue specimen.
P96. The method of any of the process embodiment(s) P90-P95, wherein reagents from at least some of the wells come into contact with the tissue specimen and trigger one or more enzymatic reactions.
P97. The method of any of the process embodiment(s) P90-P96, wherein the one or more enzymatic reactions comprise reverse transcription of RNA of the tissue specimen and/or copying of DNA of the tissue specimen.
P98. The method of any of the process embodiment(s) P90-P96, wherein proteins and/or nucleic acids from the tissue specimen are collected into the wells.
P99. The method of any of the process embodiment(s) P90-P98, wherein the nucleic acids comprise RNA and/or DNA.
P100. The method of any of the process embodiment(s) P90-P99, wherein one or more enzymatic reactions between said proteins or nucleic acids from the tissue specimen and the at least one reagent occur in at least some of the wells.
P101. The method of any of the process embodiment(s) P90-P100, wherein one or more chemical reactions occur in the wells between the tissue specimen in the wells and content of the wells.
P102. The method of the process embodiment(s) P101, wherein the one or more chemical reactions comprise reverse transcription of RNA of the tissue specimen; and/or PCR amplification of DNA of the tissue specimen; and/or binding of antibodies to proteins of the tissue specimen.
P103. The process of any of the process embodiment(s) using the plate of any of the plate embodiments.
P104. The method of any of the process embodiment(s) on the system of any of the system embodiments.
S105. The system of any of the system embodiments, carrying out the process or method of any of the process embodiments.

The above features, along with additional details of the invention, are described further in the examples herein, which are intended to illustrate the invention further but are not intended to limit its scope in any way.

### BRIEF DESCRIPTION OF THE DRAWINGS

Objects, features, and characteristics of the present invention, as well as the methods of operation and functions of the related elements of structure, and the combination of parts and economies of manufacture, will become more apparent upon consideration of the following description and the appended claims with reference to the accompanying drawings, all of which form a part of this specification.

FIG. 1A depicts aspects of a microfluidic device for emulsification according to exemplary embodiments hereof.

FIG. 1B is a microfluidic device for emulsification according to exemplary embodiments hereof.

FIG. 1C depicts droplets according to exemplary embodiments hereof.

FIGS. 2A-2B depict aspects of a configuration of a matrix device and process of operation according to exemplary embodiments hereof.

FIG. 2C depicts a matrix device having a 4×4 matrix, according to exemplary embodiments hereof.

FIG. 2D depicts a 4×4 matrix device after droplet loading, according to exemplary embodiments hereof.

FIGS. 3A-3D depict aspects of another configuration of a matrix device and a process of operation according to exemplary embodiments hereof.

FIG. 4A depicts aspects of emulsification of reagents in parallel that feed into a matrix device according to exemplary embodiments hereof.

FIGS. 4B-4D depict aspects of emulsification and storage of reagents in various formats according to exemplary embodiments hereof.

FIGS. 5A-5B depict aspects of creating a 4×4 matrix of reagent combinations with known locations according to exemplary embodiments hereof.

FIGS. 5C-5D depict aspects of creating a m×n matrix of reagent combinations with known locations according to exemplary embodiments hereof.

FIG. 6 is a flowchart of utilizing the system and the approach for combinatorial drug screening, according to exemplary embodiments hereof.

FIG. 7A depicts a 16×16 matrix device for combinatorial drug screening in which the drug combinations may be barcoded by the location in the matrix according to exemplary embodiments hereof.

FIGS. 7B-7D show a process of loading drugs/cells according to exemplary embodiments hereof.

FIGS. 7E-7G show the results of drug screening according to exemplary embodiments hereof;

FIGS. 8, 9A-9E, 10A-10C, 11A-11C, and 12A-12G depict aspects of a high content in-situ transcriptomics system according to exemplary embodiments hereof; and

FIGS. 13A-13E depict aspects of a drug synergy prediction model framework according to exemplary embodiments hereof.

### DETAILED DESCRIPTION OF EXEMPLARY EMBODIMENTS

### Description

First various novel components and systems are described, followed by various applications thereof.

### The Components

### The Emulsifier (Emulsifying Device)

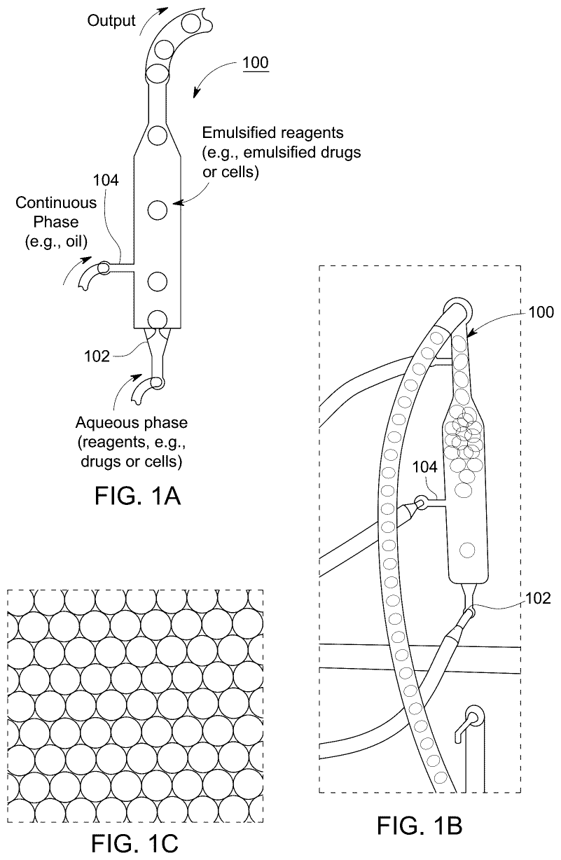

FIG. 1A depicts aspects of a microfluidic device 100 for emulsification according to

exemplary embodiments hereof (e.g., for emulsifying aqueous phase into monodispersed droplets in oil phase).

With reference to FIG. 1A, the emulsification device 100 emulsifies reagents individually into droplets in surrounding immiscible continuous phases such as fluorinated oil, mineral oil, silicone oil, or any other immiscible material. The reagents may be drugs, an oligonucleotide, a cell, a cluster of cells, an organoid, a tissue sample, a dye, a protein, an enzyme, a buffer, lyophilized materials, an antibody, dNTPs, reverse transcriptase, or any other material.

When the reagents are drugs, the drugs may be chosen, e.g., using a drug synergy prediction model, e.g., that uses machine learning to predict synergy responses from drug combinations (as described below).

An exemplary emulsifying device 100 is a microfluidic device that emulsifies reagents, has an input channel 102 for dispersed phase (reagents) and an input channel 104 for continuous phase.

A number of methods and devices may be used to create monodisperse droplets, such as flow focusing, T junction, step emulsifiers, and others. Upon applying pressure, such as negative or positive pressure, the device continuously produces monodisperse droplets of reagents until the reagent is consumed or the pressure is terminated. The size of the droplets can be tuned, as desired, by designing or adjusting the dimension, shape, and wettability of the input channel 102 of the dispersed phase or the flow rates. In a preferred embodiment, the droplets may range in diameter approximately from 10 μm to 1 mm. The dimension of the input channel 102 of the dispersed phase may range from 10 μm to 1 mm in both width and height. The shape may be rectangular, circular, or sector shaped. The wettability may be hydrophilic or hydrophobic, depending on the material of the device and surface treatment. The continuous phase may be hydrocarbon oil, mineral oil, silicone oil, fluorinated oil without surfactant or with surfactant at 0.0001 to 10 percent volume by volume percent, or other materials.

FIG. 1B shows operation of the microfluidic emulsification device 100 of FIG. 1A, according to exemplary embodiments hereof. FIG. 1C shows the monodispersity of droplets produced by the device 100.

### The Matrix

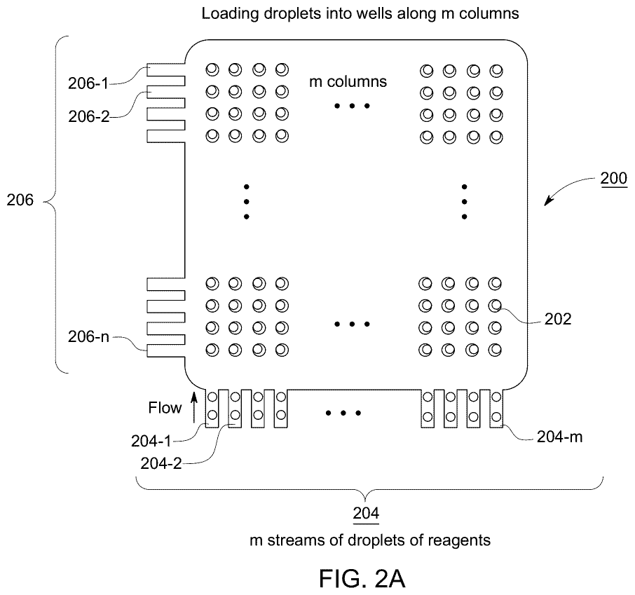

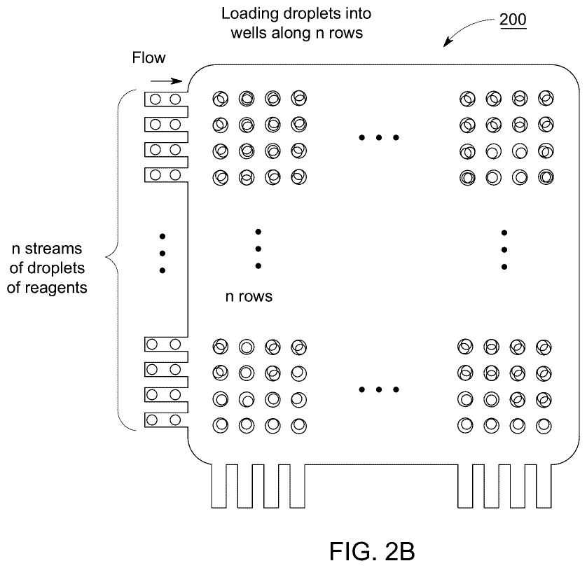

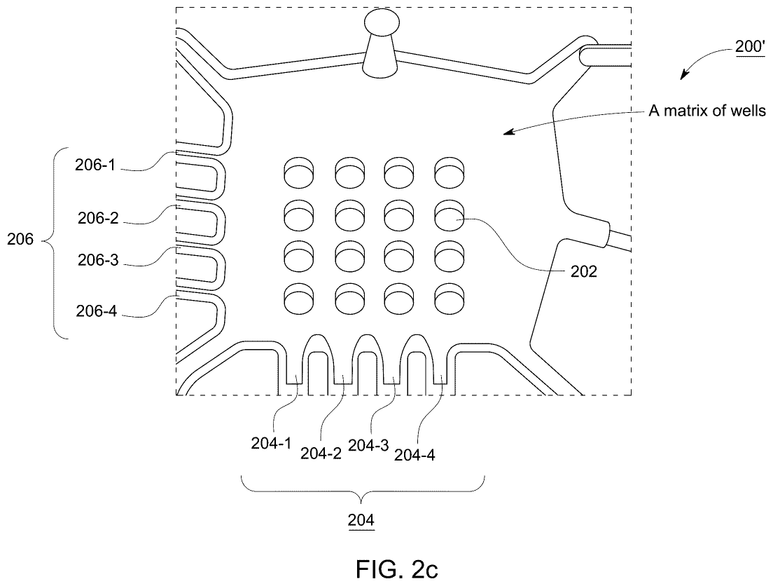

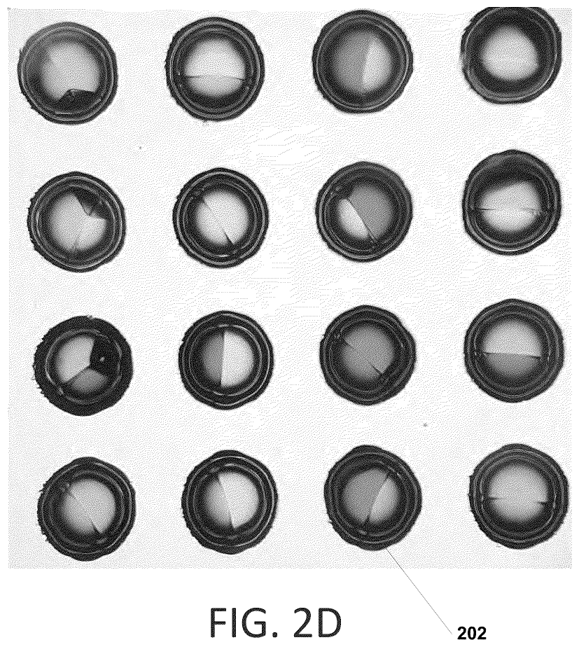

FIGS. 2A-2B depict aspects of a matrix device 200 according to exemplary embodiments hereof. As shown in FIG. 2A, an exemplary matrix device 200 has an m×n matrix of wells 202 (m columns and n rows) open to a chamber (to avoid clutter in the drawings, only one well 202 is labeled). An array of p channels 204-1, 204-2 . . . 204-p (individually and collectively channel(s) 204) is aligned with the columns of the wells, and an array of q channels 206-1, 206-2 . . . 206-q (individually and collectively channel(s) 206) aligned with the rows of the wells 202. The number of columns (m) and rows (n) may be the same or different.

The number p of channels 204 may (but need not) be equal to m (i.e., p=m or p≠m). The number q of channels 206 may (but need not) be equal to n (i.e., q=n or q≠n). In the example in FIG. 2A, the number of channels 204 is the same as the number of columns (p=m), and the number of channels 206 is the same as the number of rows (q=n).

The number of columns and rows may be one, two, three, four, or any number up to 192, or higher, depending on the size and spacing of the wells and the footprint of the device.

The channels may point to the centerline of the columns or rows or to the middle of two columns or rows (e.g., between two adjacent columns and/or rows). The wells may be spaced out 10 μm, 20 μm, or up to 1 mm, or 2 mm. The wells 202 may be spaced evenly or unevenly between columns and/or rows.

Thus, a well 202-i-j at row i, column j in the matrix device 200 may get droplets from a channel 206 corresponding to or associated with row i and from a channel 204 corresponding to or associated with column j. In some cases, well 202-i-j will get droplets from channel 206-i and from channel 204-j.

In the exemplary matrix device 200 shown in FIGS. 2A-2B, p streams of droplets of reagents and q streams of droplets of reagents may be loaded into batches from their corresponding channels integrated into or with the matrix device. As noted above, in some cases, p=m and/or q=n.

Those of skill in the art will understand, upon reading this description, that an advantage of the arrangement of wells and channels when the test readout is performed in situ—in the wells, is that as reagents are loaded from the columns and rows, the content of the reagents is in situ recorded by its location in the matrix. This approach to recording location preserves the identity of the droplets and, for some embodiments, eliminates the need for droplet barcoding such as optical dye barcodes, DNA barcodes, or other identifiers. This significantly lowers the cost and simplifies the workflow and systems involved in liquid handling. While droplet barcoding is not needed in some embodiments, it should be appreciated that droplet barcoding may be used or even required in some embodiments (e.g., when the association between droplets and wells is not available). For example, as described below, in some cases, DNA barcodes may be added to well locations, and then the materials from all the wells may be collected together. In such cases, the DNA barcodes may be used to indicate which well the DNA sequences come from.

The matrix device 200 may be configured in various modes, as described here.

In a first mode, the matrix of wells 202 and the two sets of loading channels (204, 206) may be integrated into or with the same device (e.g., as a seamless component), e.g., as shown in FIGS. 2A-2B. To operate in this first mode, streams of droplets containing known reagents may be loaded into the matrix of wells filled with oil through channels pointing to the columns by applying a vacuum and/or positive pressure. The trajectory of each stream of droplets may be aligned with the corresponding column(s) by gravity, buoyancy, guiding channels, grooves, and/or structures (e.g., posts) to prevent droplets in one column from entering or drifting to an adjacent column. A stream of droplets fills all the wells along its corresponding column by gravity, buoyancy, hydrodynamic trapping, pushing, and/or suction. The wells are designed so that once a droplet enters a well, the droplet stays in that well without further disruption. Once a well reaches its filling capacity, subsequent droplets pass that well without filling it.

The shape of the wells 202 may be cylinder, cube, cuboid, dome, triangle, hexagon, or one or more of these shapes, combined vertically or horizontally. The shape of the wells may be designed to allow droplets to be released from the wells by flipping or tilting the device. This takes advantage of buoyancy, gravity, hydrodynamic force, and/or mechanical capturing, etc. The shape of the wells may be designed to allow the release of a selective number of droplets by flipping or tilting the device. The well size and shape may be designed to accommodate one, two, three, four, five, six, seven, eight, nine, ten droplets, or more, depending on the applications.

The wells 202 may be serially populated by drops. For example, the wells may be populated by a first reagent from a first reagent library with a single drop per well, and then each well may be further populated by a second reagent drop from a second reagent library totaling two drops per well. As noted, wells may be sized with enough room to house multiple drops from multiple reagents, as needed.

The number of drops occupying each well in each step of the drop collection process may be controlled, e.g., by tilting the matrix device 200 to release extra drops in the well, thereby maintaining only the desired drop number per well. For example, to keep only one drop in a well 202, the device 200 may be tilted close to 90 degrees until, by buoyancy, all but a single drop remains in each of the wells.

Once the first drop is loaded into a well, a second drop may be added. The device may then be tilted to a lesser degree. For example, the device can be tilted at a 60-degree angle to ensure that only two drops are loaded in each well. This process may repeat as needed where the device is tilted by a lesser degree with every additional drop that should be trapped in the wells to remove undesired surplus drops and ensure only the desired number of drops remain in each well.

The wells may be sized so that once a well is occupied by a drop, there is no room for additional drops to take residence.

In some cases, different size drops may find residence in the same size well. Once the wells are filled, for example, along the columns, a second batch of droplets can be loaded through the channels, for example, along the rows, by a similar mechanism. After loading from columns and rows, each well contains two species of reagents which can be the same or different depending on the setup of the reagents (see, e.g., FIG. 2D). The content of a reagent combination may be determined by its location in the matrix. The process may be repeated to construct more complicated combinations of reagents in the matrix of wells. The reagent droplets in wells may be merged (e.g., by applying electrical fields, acoustic waves, mechanical agitation, evaporation of oil, or flowing chemicals such as PFO to induce merging).

FIG. 2C shows an exemplary matrix device 200′ having a 4×4 matrix of cells. The matrix device 200′ has four “vertical” loading ports 204-1, 204-2, 204-3, 204-4 (collectively and individually 204), and four “horizontal” loading ports 206-1, 206-2, 206-3, 206-4 (collectively and individually 206). (The terms “vertical” and “horizontal” are used to describe the orientation in the picture in FIG. 2C.) In this example, the loading ports feed corresponding channels that are aligned with the wells 202.

In the example in FIG. 2D (from a microscopic photo showing a 4×4 array of wells in the matrix device of FIG. 2C after loading), each well contains two droplets from the corresponding column and row.

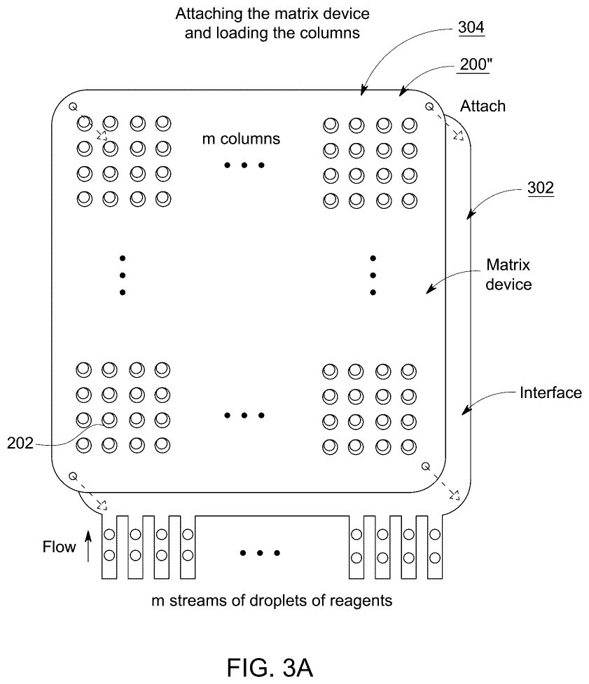

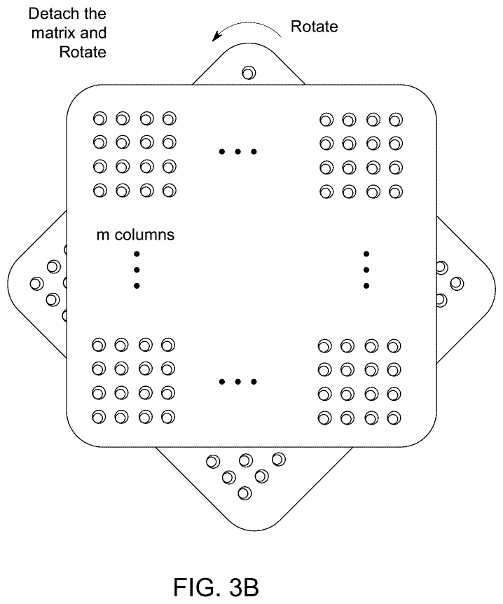

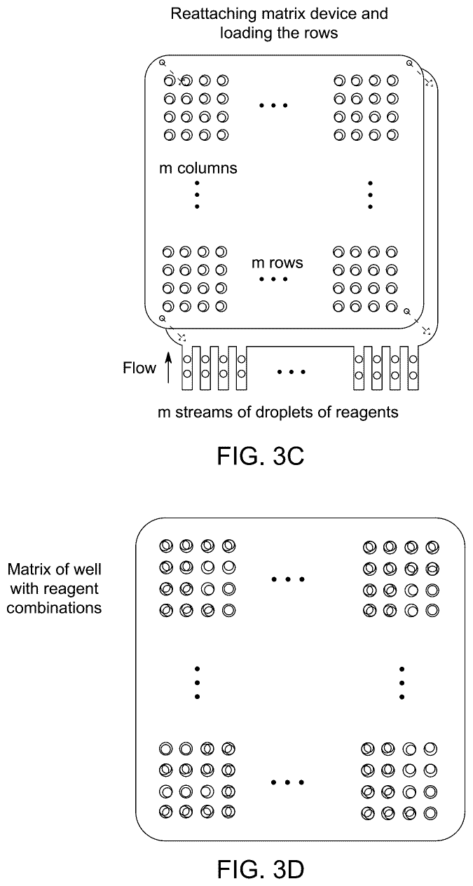

In a second mode, e.g., as shown in FIGS. 3A-3D, a well module 304 (comprising the matrix of wells 200″) and the loading module 302 are two separate modules that can be repetitively attached and detached from each other. The loading module 302 comprises loading channels from which streams of droplets may be introduced leading into a region where streams of droplets can flow. The trajectories of the droplet streams may be aligned with the columns or rows in the well module once attached. The loading module 302 may have two separate sets of channels for loading from columns or rows. This setup is compatible with matrices that have both the same or different numbers of rows and columns. Or the loading module 302 may have one set of channels for loading both columns and rows. The well module 304 (with the matrix of wells 200′) may be attached to the loading module 302 by applying pressure via mechanical components such as clamps or screws or the like, by friction, or by for example a glue or other sealing material. When attached, the well module and channel module form a seal that prevents leaking of air and liquid through the interface. In some embodiments, once attached, droplets may be loaded into wells along the columns in a similar fashion as in the first mode. The well module 304 may then be detached and reattached to load droplets into the rows. The combined reagents of interest may be selectively retrieved with a pipette or similar liquid transfer device, after detaching the well module 304. Those of skill in the art will understand, upon reading this description, that an ancillary benefit of the decoupling of matrix wells and the loading module is that the matrix wells can be prepared and stored to build inventory or enable production pipelining. For example, a collection of matrices may be prepopulated with one or more drops in the wells. Those matrices may then be used in subsequent processes, where one or more additional drops may be added to the wells.

Operation of the second mode (FIGS. 3A-3C) may be summarized as (i) attach the matrix device to the interface and load wells along the columns (FIG. 3A); (ii) detach the matrix device and rotate 90 degrees (FIG. 3B); (iii) reattach the matrix device and load the rows (FIG. 3C). FIG. 3D shows a matrix of wells containing reagent combinations.

In a third mode, the device with a matrix of wells may have a detachable ceiling.

The ceiling may be attached to the wells mechanically to form an air-tight seal when loading the droplets. At least two devices are filled with droplets. The ceilings of the devices may then be detached so that the droplets are trapped in the wells and are exposed on the top and the bottom of the wells. The devices may then be aligned and stacked to vertically combine droplets in the wells across all the devices. The droplets may be combined via centrifuging the devices.

In a fourth mode, the device has at least two layers of well matrix with a rod in the center. The rod allows for rotation of the layers. The top layer comprises a matrix of wells open on one side. The bottom layers comprise a matrix of wells open on both sides. The layout of the wells in all the layers is identical. The interface between layers can be sealed when loading droplets into the matrices of wells. Droplets are first loaded into the device along the columns in a similar manner as described in the first and second modes. Each well in each layer has at least one droplet. The wells in the same location across layers have the same type of droplets. To combine droplets of different types, one layer is rotated 90 degrees so that droplets along the columns in one layer meet the droplets along the rows in the other layer.

The well and channel components may be manufactured by various methods including soft lithography, etching, hot-embossing, laser cutting and lamination, 3D printing, machining, etc., or a combination of thereof. The material of devices in the system may be PDMS, PMMA, polystyrene, COC, glass, polycarbonate, etc., or combinations, thereof. The modules in the system in the embodiments herein may be fabricated with the same or different materials. Depending on which material is used, the surface properties (such as hydrophilicity) may be tuned to change how liquid wets the surface or prevents molecules in the liquid from penetrating the material.

### Configuring the Components [The Emulsifying Device & the Matrix]

The two components, that is, the emulsifying device (e.g., as shown in FIG. 1A) and the matrix (e.g., as shown in FIGS. 2A-2B), may be configured in several modes.

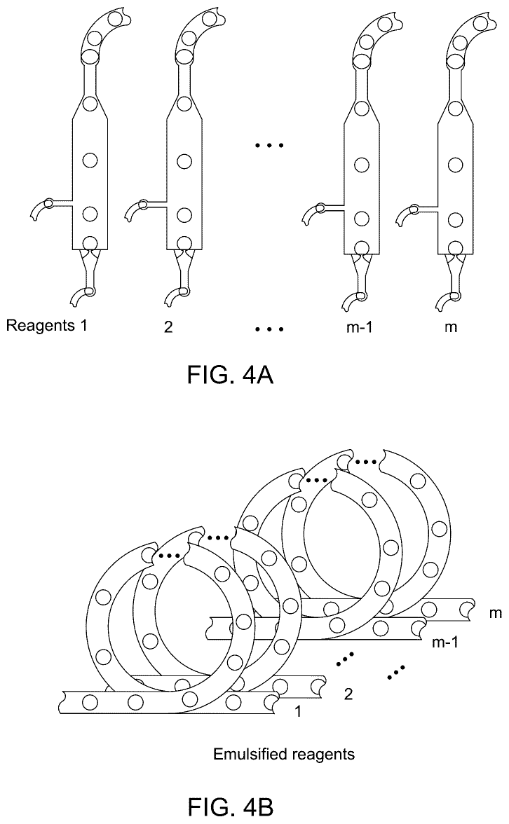

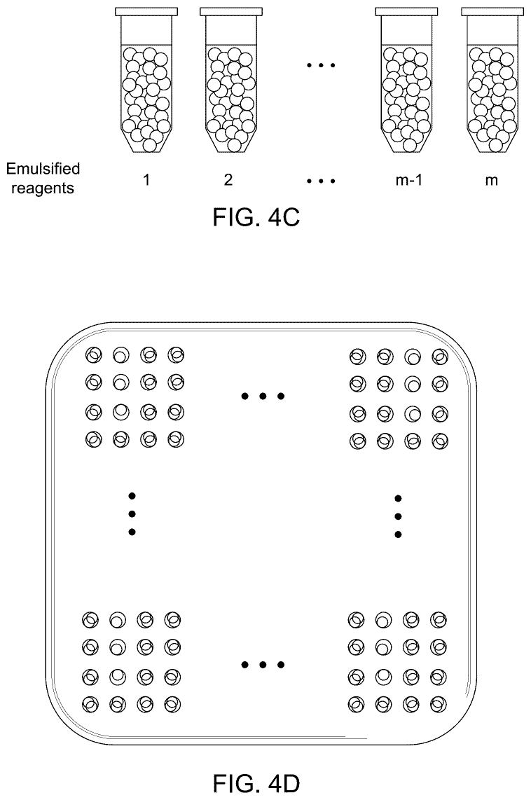

For example, one or more emulsifying devices (e.g., emulsification device 100) may be connected to a matrix via tubing made of materials such as silicone, PTFE, PE, PP, metal, etc. Alternatively, one or more emulsifying devices may be integrated with the matrix into one monolithic component. The components may be operated simultaneously or at different times. In one embodiment, the emulsifying device(s) and matrix operate simultaneously, the emulsifying device(s) emulsifies an array of reagents and feeds into the second matrix (see, e.g., FIG. 4A, depicting aspects of emulsification of reagents in parallel that feed into a matrix device according to exemplary embodiments hereof, using m emulsification devices 100-1, 100-2 . . . 100-m).

Alternatively, reagents can be pre-emulsified and stored. Accordingly, in another embodiment, with reference to FIGS. 4B-4D (depicting aspects of emulsification and storage of reagents in various formats according to exemplary embodiments hereof) the emulsifying device(s) (e.g., emulsification device(s) 100) emulsify reagents which may then be stored in intermediate containers, which may include but is not limited to tubes, tubing (FIG. 4B), vials (FIG. 4C), microtiter plates, other matrices, and other storage devices. Typically, these devices should be made of materials that are inert to the reagents. The stored droplets of reagents may be loaded into the matrix at a different time. The emulsified reagents can also be stored in the matrix, and more droplets of reagents can be added to the matrix at a different time (see, e.g., FIG. 4D).

### EXAMPLES

### Generating Spatially Barcoded Combinations of Reagents in Droplets in a Matrix Device.

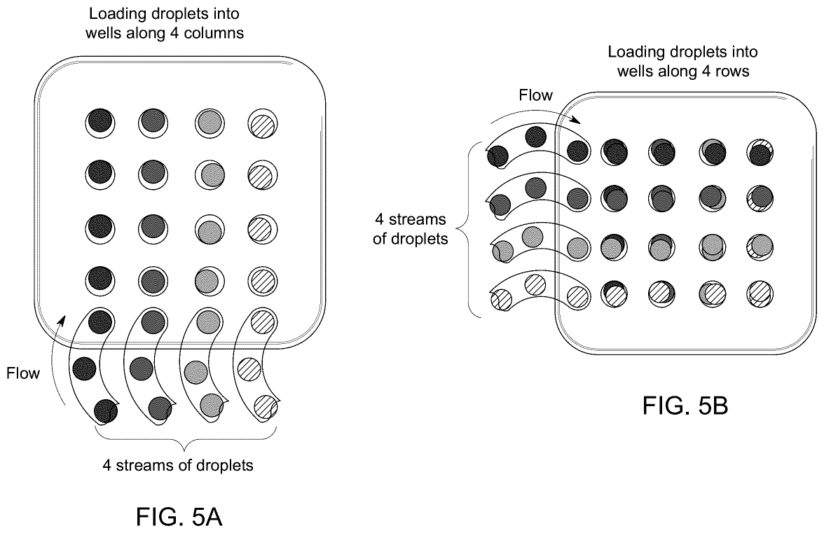

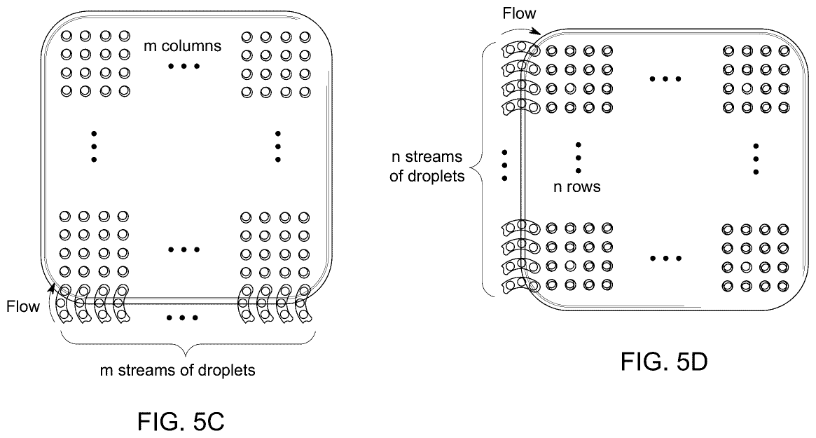

FIGS. 5A-5B depict aspects of creating a matrix of reagent combinations with known locations according to exemplary embodiments hereof. An example is shown of creating a 4×4 matrix with 16 unique reagent combinations. Four reagents are emulsified as droplets and loaded into wells along the corresponding columns (FIG. 5A). Another four emulsified reagents are then loaded into wells along the rows (FIG. 5B) forming a matrix of reagent combinations. The combinations can be identified by their locations in the matrix.

FIGS. 5C-5D depict aspects of creating an m×n matrix of reagent combinations with known locations according to exemplary embodiments hereof (based on the same principle described above with reference to FIGS. 5A-5B).

FIG. 2D is an image of a 4×4 matrix device after droplet loading, according to exemplary embodiments hereof.

### Combinatorial Drug Screening

The system may be used for combinatorial screening of molecules such as compounds in therapeutic development.

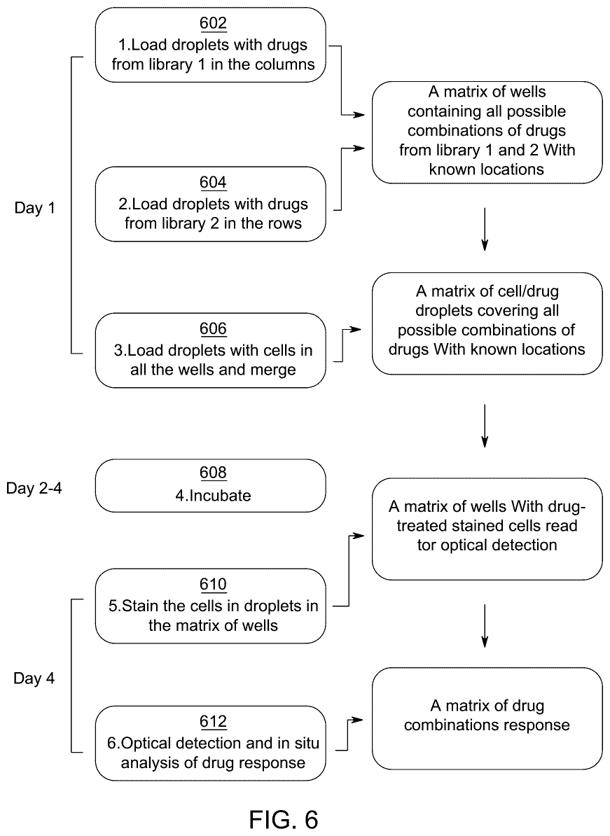

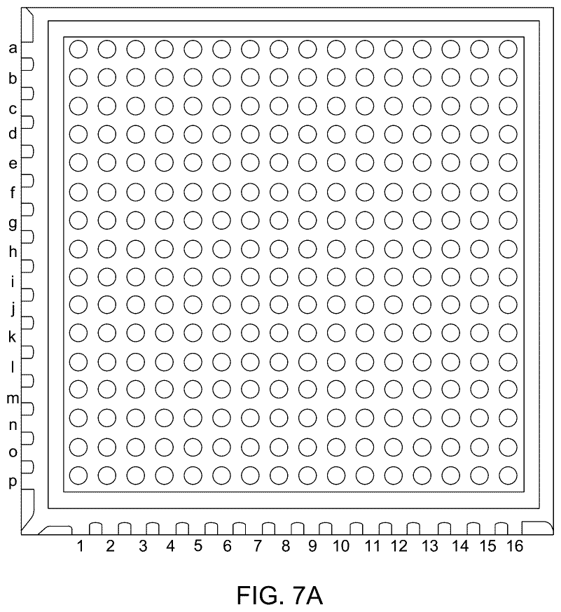

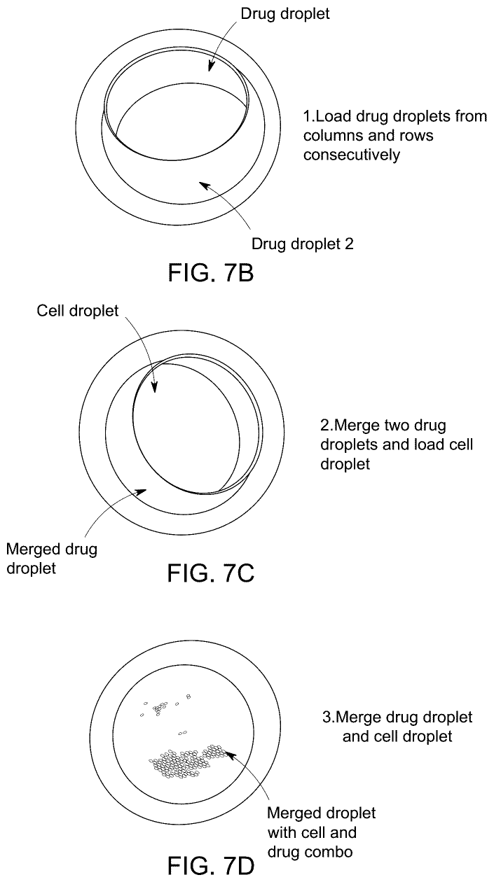

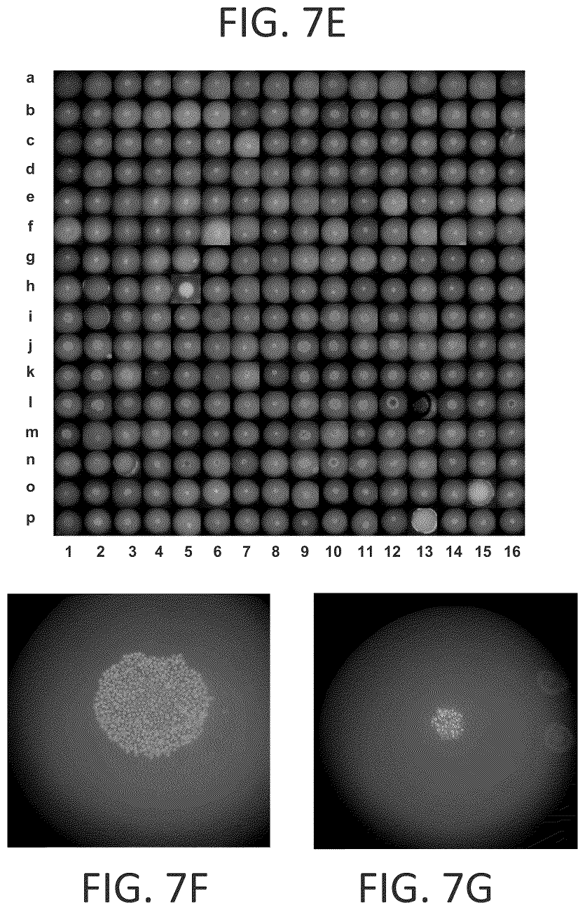

In one example, with reference to FIGS. 6 and 7A-7G, a screening of 16 by 16 compounds is performed.

FIG. 7A is a microscopic image of a 16×16 matrix device according to exemplary embodiments hereof. Drugs 1-16 and drugs a-p are emulsified and loaded in the corresponding columns and rows consecutively. FIGS. 7B-7D are microscopic images showing droplets in one example, well in the 16×16 matrix device at different stages in the process.

With reference first to FIG. 6, the device containing a matrix of wells is loaded with sixteen emulsified compounds using the columns and sixteen using the rows (at 602, 604). Emulsified cell droplets are added across the matrix array (at 606). The resulting populated wells have two droplets of compounds (one from the columns and one from the rows) and one droplet of cells. Alternatively, cells could be loaded first, and column and row droplets would follow. The loading sequence may be any combination such as column-compounds, row-compounds, cells, or cells, column-compounds, row-compounds, or row-compounds, cells, column-compounds, and so on. Each batch of compounds may be loaded and stored at different times (e.g., on different days), enabling efficiencies of batch production, or may be loaded nearly contemporaneously. Loading of compounds at different times may be tailored for different applications. For example, it may be desired to first expose cells to the column-compounds for an incubation period and then add the row-compounds. Similarly, the addition of compounds may be repeated multiple times through the columns and the rows as required by the workflow.

After loading, the various types of droplets co-located in each well are merged into one larger droplet to combine the cells and compounds. Droplets may be merged after loading all droplets. Alternatively, a subset of droplets may be merged first, and then an additional droplet brought in contact and merged sequentially (FIG. 7B depicts this merging for three drops). After merging, the oil connecting the wells is replaced with air or some other gas to prevent inter-drop transportation of compounds. The device is then incubated in a cell culture incubator for a few days depending on the experimental design (at 608). In this example, after incubation, a staining assay is emulsified, loaded in all the wells, and merged with the previously loaded and merged droplets (at 610). In other uses, different types of materials may be combined. In this example, the staining assay is a mixture of calcein-AM and ethidium homodimer to stain live cells green and dead cells red. In other uses, experimental readout could be other types or staining assays such as apoptosis, proliferation, pathway activation, cell-surface markers, or other assays. The wells are then imaged for cell viability assessment (at 612). In one embodiment, we use standard fluorescent imaging systems such as a microscope or an imager to assess the effect of each of the (256) drug combinations in wells. These images are used to evaluate cell viability, proliferation (FIGS. 7C-7E), apoptosis, morphology, synergy (in the case of drug compounds), etc. The content of drug-drug combinations is indicated as it corresponds to the location of the wells in the matrix. In some cases, bright-field images of unstained cells may be taken if the number or morphology of cells is the parameter of interest. Cells in any wells of interest in the matrix may be retrieved to conduct downstream analysis.

FIG. 7E is a fluorescent image of the 16×16 matrix after three days of incubation and staining. FIG. 7F is a zoom-in image of one well in the matrix with an ineffective drug combination and FIG. 7G is a zoom-in image of one well in the matrix with an effective drug combination.

As should be appreciated, the approach described may be orders of magnitude faster and cheaper than the current industry standards - a robotic liquid handling system. The method is also much simpler compared to other newer methods because it allows for the identification of droplets preserved by the ordered placement created by the geometry of the matrix, thus eliminating the need for barcodes such as fluorescent agents oligonucleotides to identify each combination of reagents or other identifiers. The systems disclosed herein significantly reduce the cost of materials (such as fluorescent dyes or oligonucleotides) and complexity of detection (instrumentations such as multi-color fluorescent imager or DNA sequencer) necessary to trace the response of each chemical or biological combination. In addition, microfluidic methods that rely on randomly coupled droplets identifiable by, for example, optical or DNA barcodes must rely on overproduction of random combinations to ensure a good statistical representation of every possible combination in the set. Those other methods are inefficient and consume materials such as cells, reagents, and compounds, which may not be available, are expensive, or scarce (as in primary patient cells in the pursuit of diagnostics or personalized medicine). Whereas, this system, by design, ensures that all material combinations occur at the required frequency, eliminating the need for statistical oversampling.

The drugs (or drug combinations) may be chosen, e.g., using a drug synergy prediction model, e.g., that uses machine learning to predict synergy responses from drug combinations (as described below).

### Transcriptomics Systems

Aspects of the matrix system described herein may be used in a high-content in-situ transcriptomics system, as described here.

According to exemplary embodiments hereof, a system employs a grid of channels that delivers minute volumes of (nanoliter size) reagents via emulsion droplets directly into a grid of fine pitched wells. A plate (e.g., a matrix as described above) is pre-filled with the reagents needed for reverse transcription of cellular RNA. Pre-filled plates may be stored, and, when needed, a plate may be pressed onto a tissue sample to generate location-barcoded cDNA.

Once filled (or pre-filled), each nanowell, in a plate (matrix) contains barcoded oligonucleotides corresponding to its location in the grid. Each well would also include reverse transcription reagents.

Preferably each plate is 100% filled, with every well containing the required barcoded oligonucleotides and reverse transcription reagents and any other required content. However, different degrees or percentages of filled wells are acceptable and contemplated herein. E.g., 95-100% filled, 90-100% filled, 85-100% filled, and 80-100% filled.

After standard tissue processing, users clamp a plate to a tissue slide (fresh-frozen or FFPE—Formalin-Fixed Paraffin-Embedded). The plate and matrix sandwich is then incubated at an appropriate temperature for cDNA reverse transcription. After incubation, the contents of all nanowells are pooled.

The plates are produced, e.g., as described below, to fill each column and row with uniquely barcoded droplets and reagents.

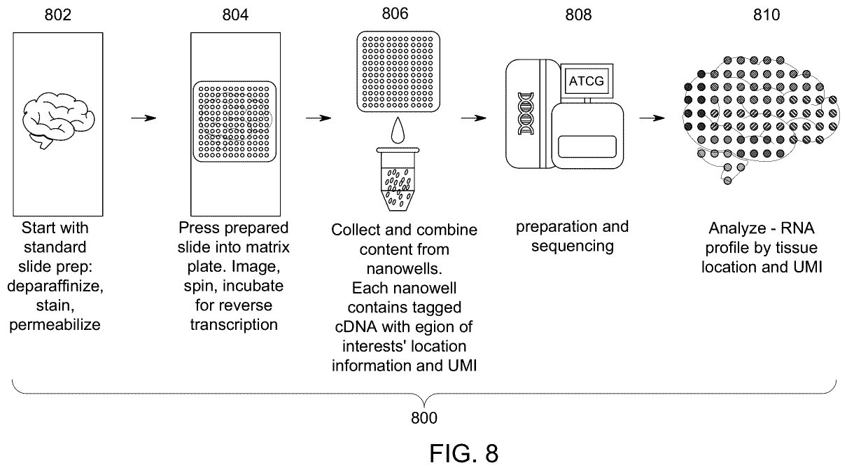

Thus, with reference to FIG. 8, an exemplary workflow 800 starts with standard preparation of a tissue slide (e.g., deparaffinize, stain, permeabilize) at 802.

The prepared tissue slide is then pressed into a pre-populated matrix plate (at 804) (i.e., a matrix plate with pre-populated wells). The pre-populated matrix plate is described in greater detail below. The result is imaged, spun, and incubated for reverse transcription.

After this process, each nanowell contains tagged cDNA with region of interests' location information and unique molecular identifiers (UMIs). Content from the nanowells is then collected and combined (at 806).

Standard preparation and sequencing are then performed at 808.

The RNA profile is then analyzed (at 810) by tissue location and UMI. For example, an image of the original tissue (from the tissue slide) may be overlaid with RNA information.

### Pre-Populated Matrices

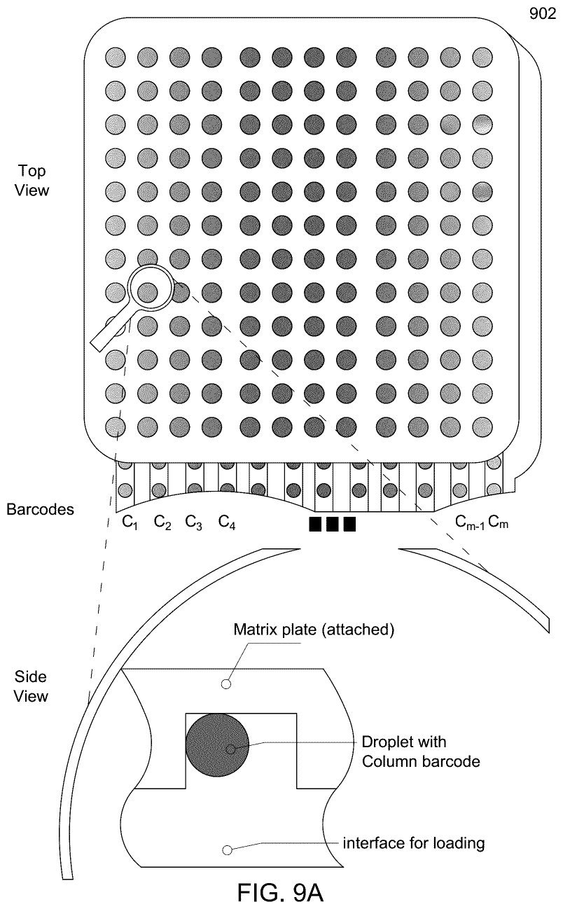

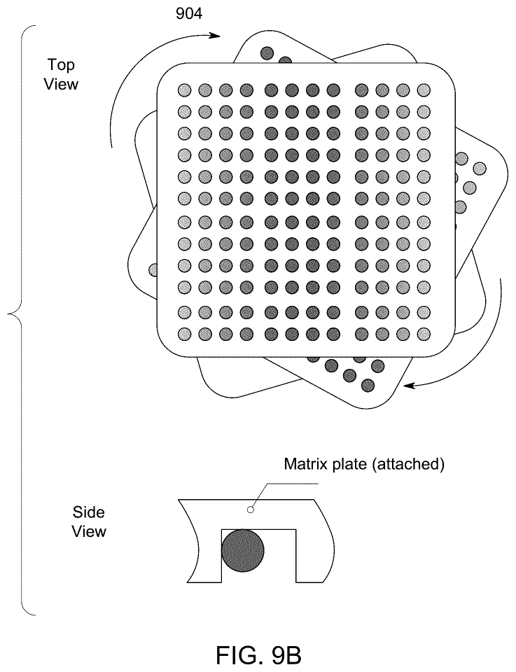

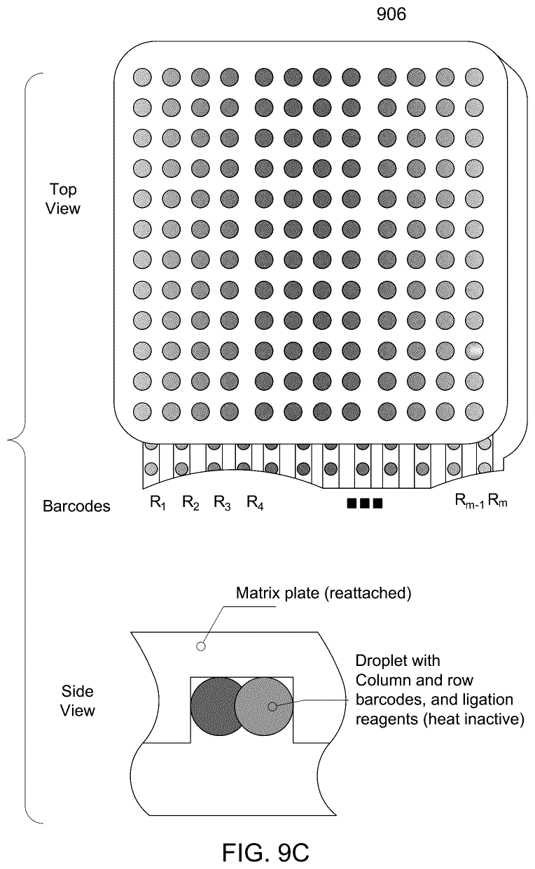

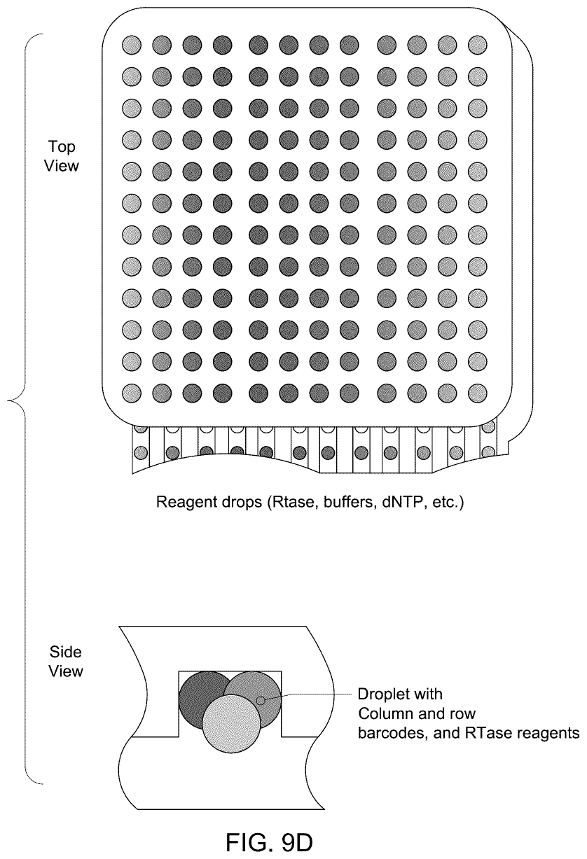

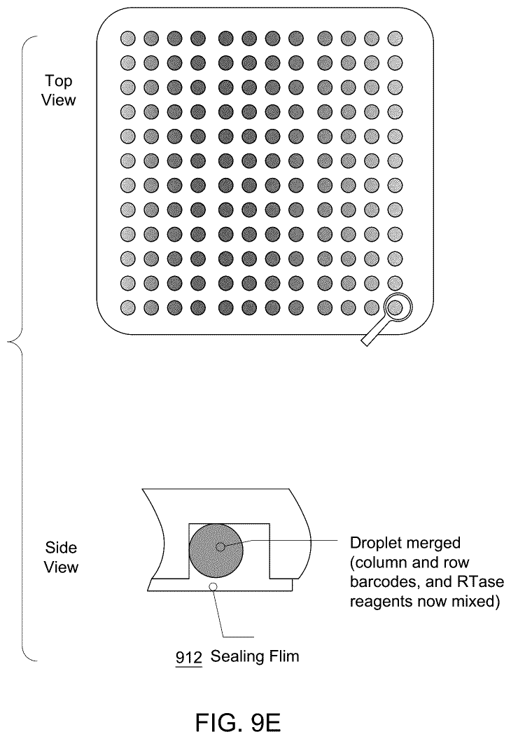

Pre-populated plates or matrices for use in the above-described workflow may be made as follows, with reference to the workflow in FIGS. 9A-9E. The process may use a matrix such as described above with reference to FIGS. 3A-3D, in which the matrix device is attachable to (and detachable from) an interface.

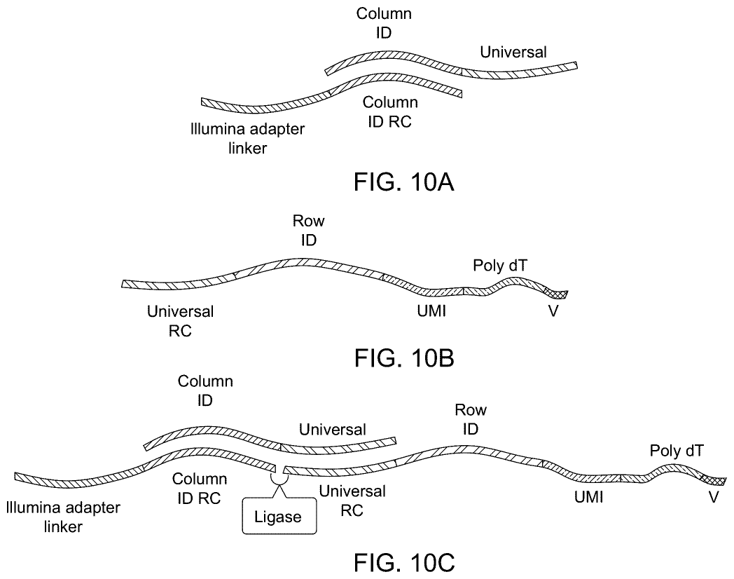

First, the columns of wells are loaded with emulsified column barcodes (C₁, C₂, . . . Cₘ) (at 902, FIG. 9A). A side view in the drawing shows a nanowell with a droplet having a column barcode. A well in the j-th column will have a droplet with the column barcode Cⱼ. FIG. 10A shows column oligo barcodes introduced into the matrix.

Then (at 904, FIG. 9B), the matrix is detached and rotated 90 degrees, and then the rows are loaded with emulsified row barcodes (R₁, R₂, . . . Rₘ) and then ligate (at 906, FIG. 9C). A side view in the drawing (in FIG. 9C) shows a nanowell with a droplet having a column barcode, a droplet with a row barcode, and ligation reagents. A well in the j-th column and the k-th row will have a droplet with the column barcode Cⱼ and a droplet with the row bar code Rₖ. FIG. 10B shows row oligo barcodes, introduced into the matrix. As shown in FIG. 10C, ligation concentrates the oligos. Ligated oligos contain column/row/UMI barcodes and are ready for reverse transcription (e.g., via a Poly-Dt-V site).

Then (at 908, FIG. 9D), reagents (e.g., RTase, dNTP, a buffer, a cell, a cluster of cells, an organoid, a tissue sample, a dye, a protein, an antibody, an enzyme, and/or lyophilized materials, etc.) are added to the wells. A side view in the drawing (in FIG. 9D) shows a nanowell with a droplet having a column barcode, a droplet with a row barcode, and a droplet with reagents.

The droplets in each microwell are then merged (at 910, FIG. 9E) so that each microwell contains a merged droplet having column and row barcodes and RTase reagents, now mixed. The matrix is then sealed (e.g., with a sealing film 912) and then stored at the appropriate temperature (e.g., −20° C.).

### Clamping the Plate/Matrix to a Tissue Slide

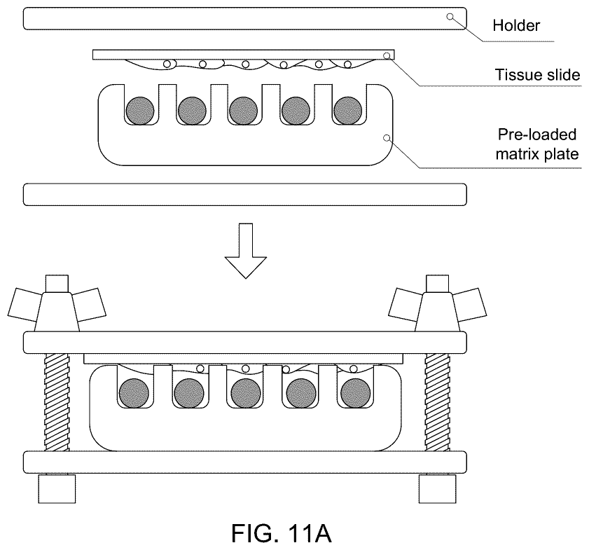

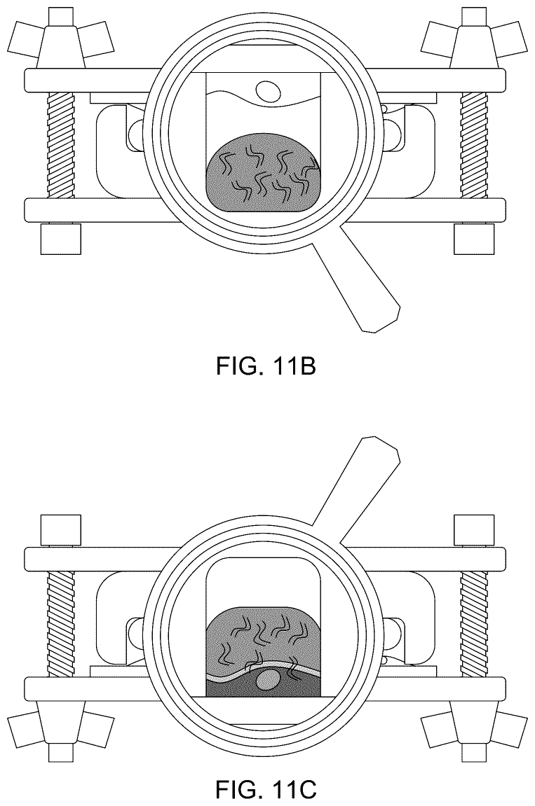

An exemplary process for clamping the matrix to a tissue slide is described with reference to FIGS. 11A-11C.

With reference to FIG. 11A, a tissue slide is placed over a pre-loaded matrix plate and clamped with a holder.

FIG. 11B is a close up of a single nanowell in profile. The green in the figure represents the reverse transcription reagents containing barcoded location oligonucleotides (oligos). The purple in the figure represents cell tissue.

FIG. 11C is a close-up of a single nanowell in the matrix after the clamped plate and tissue have been centrifuged. The spinning causes reagents in the pre-populated wells to combine with the lysed cellular material of the tissue. Then the apparatus is flipped and centrifuged again to collect the RNA into the wells.

### Example

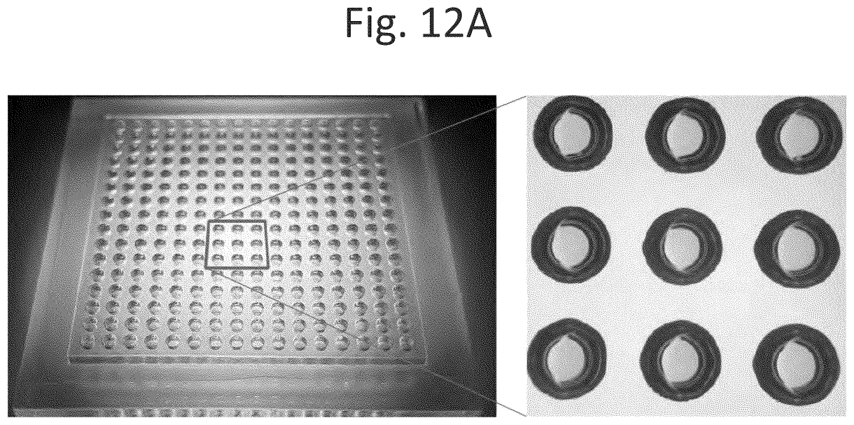

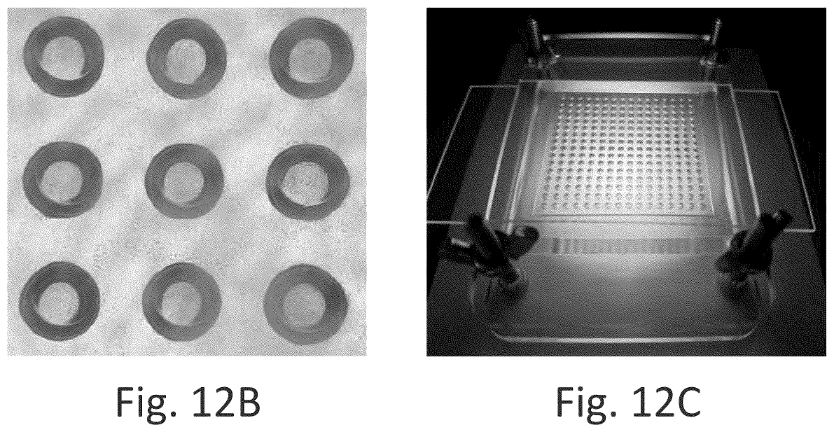

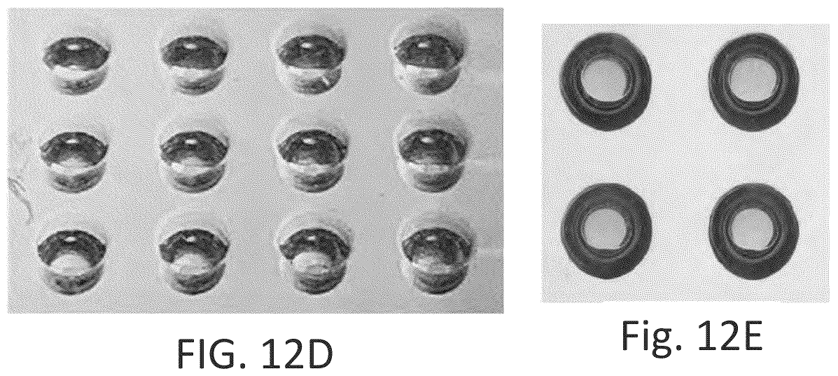

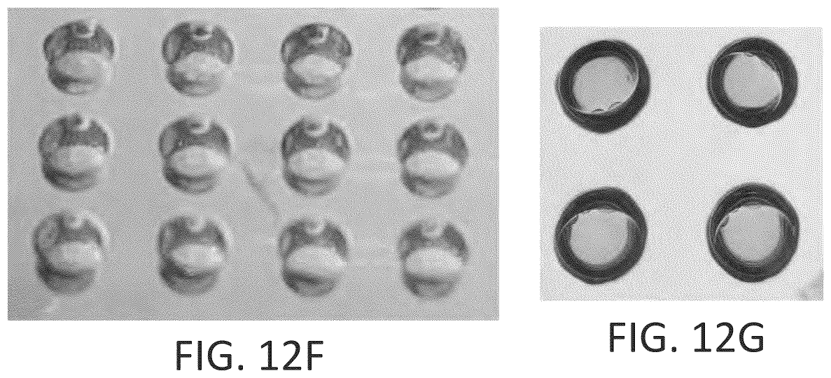

In an example, regents were introduced into wells of a nanowell plate (as described above), and then the plate with reagents was frozen (FIG. 12A). The plate was then thawed. FIG. 12B shows a close-up image of nine nanowells with reagents. Freezing and thawing did not distress the assembly. A glass slide was assembled and clamped onto the matrix (FIG. 12C). The entire assembly was centrifuged to bring the drops to the surface. This delivers the reagents into the tissue slide. FIGS. 12D and 12E show a close-up as a ¾ view (FIG. 12D) and a top view (FIG. 12E). No visible leakage of reagents was observed, and the reagents were maintained within the border of each well. As expected, the liquid is in the top of each well.

The assembly was flipped and centrifuged to bring drops back into the nanowells. The second centrifugation emulates how mRNA comes into contact with oligos (FIGS. 12F-12G). Performing this step with tissue would bring the RNA in contact with a high concentration of oligos resident in the wells and maximize cDNA reverse transcription. As can be seen in the figures, after the second centrifugation, the liquid is at the bottom of the well.

As should be appreciated, for a pathologist and others, this system may reveal insight on tissue features that could not be illuminated by staining alone. In addition, this approach enables full-length RNA-seq and identification of genetic mutations.

### Prediction and Selection of Synergistic Drug Combinations

While the approaches and systems described above work for any drug combinations, it is desirable to prioritize potentially synergistic drug combinations for high throughput screening. Accordingly, in embodiments hereof, a model is used to guide and prioritize screen drug selection.

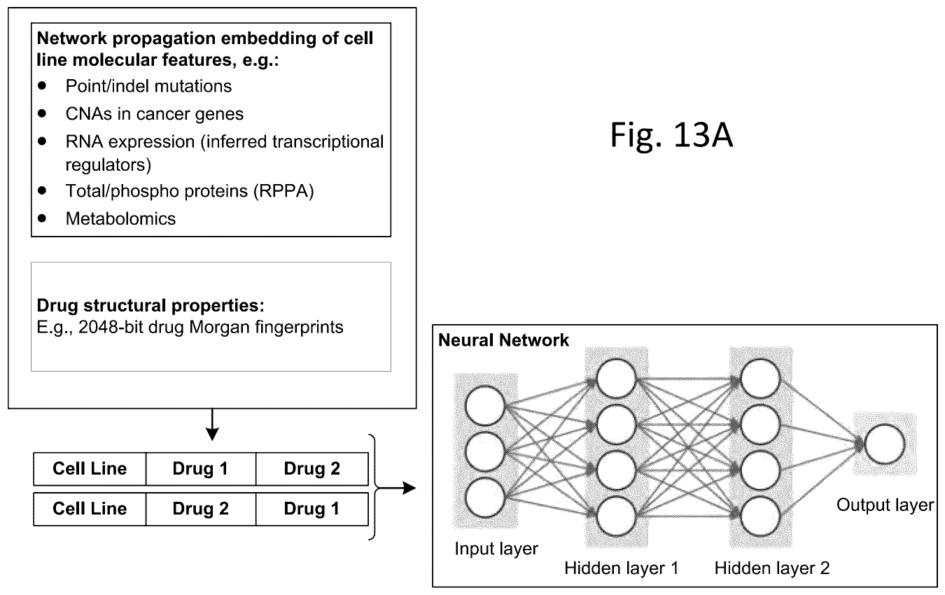

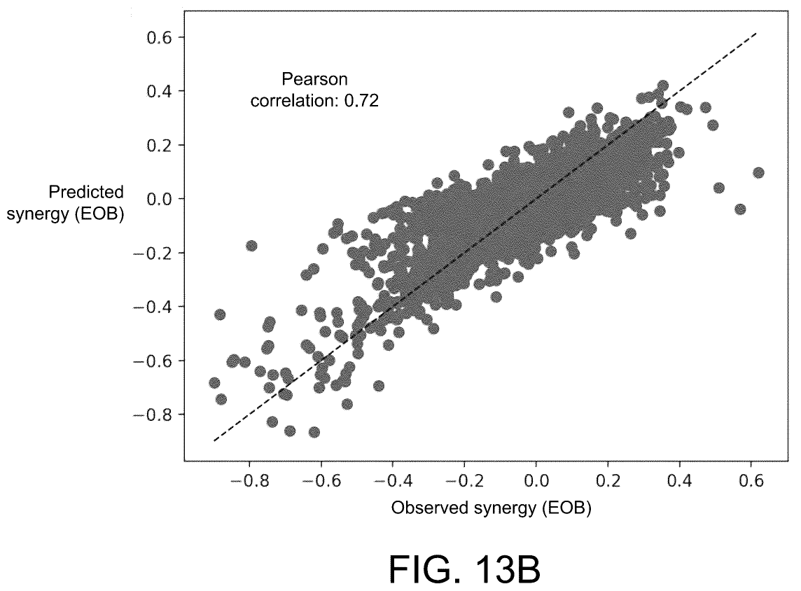

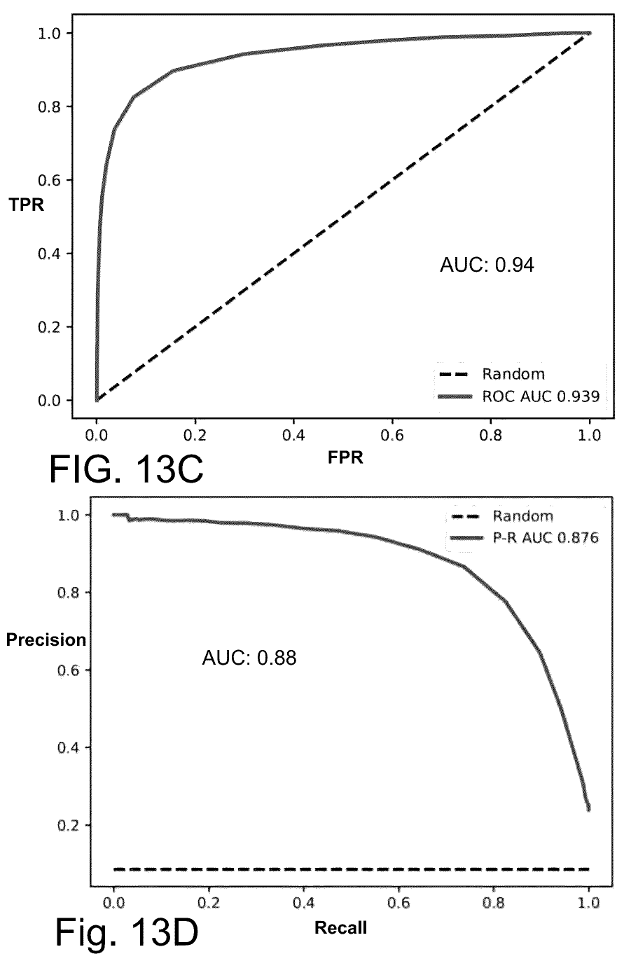

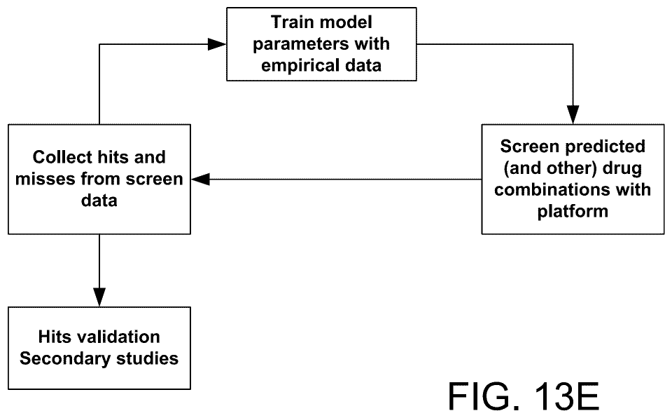

FIG. 13A depicts aspects of an exemplary drug synergy prediction model framework. The exemplary computational modeling approach comprises a regression framework that learns predictive features from cellular/tissue data and drug information to predict synergistic responses (FIG. 13A). The approach uses a conventional network biology approach to integrate available datasets describing cell or tissue-specific molecular states. The approach also uses a neural network (e.g., deep learning) to establish relationships between the input data and output responses. The neural network methodology can establish nonlinear relationships between inputs and outputs, which is distinct from traditional linear regression approaches.

Three general classes of data are required to build the models described here, namely:
(1) specimen (i.e., cell line or tissue) molecular data (input),
(2) drug compound features (input), and
(3) synergy responses determined empirically from available screen or targeted data (output).

The empirical data indicated in (3) are necessary for establishing the model parameters (i.e., input/output relationships).

In the model, information from specimen molecular data and drug compound features is integrated and used to predict the synergy responses from (3). The trained model (i.e., with parameters tuned to maximize accuracy between prediction and actual measurements) is then used to predict responses for new, previously unobserved drug combinations.

To establish specimen molecular data for input to the model, molecular data (e.g., omic data) obtained from public data sources or internal experiments are collected and mapped to an interaction network. The interaction network may be an interactome, which describes protein-protein interactions, protein-metabolite links, etc., as a series of nodes connected through edges or graph links). The public data sources may include, e.g., the Broad Institute's DepMap portal.

Network propagation is used to diffuse the influence of measured features (e.g., somatic mutations) throughout the interactome to implicate relevant network neighborhoods influenced by the individual molecular alterations. Network propagation has a simple mathematical form that is readily implemented as an iterative algorithm or with a steady-state, closed-form solution. A current implementation uses the so-called “random walk with restart” (RWR) formulation. In this context, the input to network propagation is a vector of scores assigned to nodes (i.e., proteins, metabolites, etc.) present in the interactome that describe whether or not (or how much) a given molecular feature is associated with the biological specimen. For example, if a cell line possesses a mutation in the KRAS gene, a non-zero weight is applied to it, and the algorithm diffuses this information throughout the local neighborhood connected through this node. The output of this procedure is a network embedding, which is a vector of node scores describing the local influence of molecular perturbations diffused through the network connections. Typically, undirected and unsigned interactome edges are used with network propagation, although implementations that account for sign and direction have been tested and may be used in the modeling.

For drug compound features, drug compounds' structural and/or chemical features are obtained, generally from public resources (e.g., NCBI PubChem). Such features include SMILES (Simplified Molecular Input Line Entry System) strings that describe compound structures, molecular weights, bond features, etc. A common chemoinformatic approach to represent drug molecules mathematically is fingerprinting, whereby drug molecular structures are converted to N-bit (e.g., N=2048) vectors, allowing for similarity assessments between compounds and general statistical or machine learning applications. The Morgan fingerprint, also known as an extended connectivity fingerprint (ECFP), is the most common of these techniques. These fingerprints are used in the modeling framework to enable learning drug features that, along with the cellular/tissue features from (1), specimen (i.e., cell line or tissue) molecular data, distinguish synergistic from simple additive or antagonistic responses. Those of skill in the art will understand, upon reading this description, that additional drug features can be modeled, which may include other direct molecular properties and/or knowledge of secondary cellular targets. For instance, the cellular pathways affected by these agents can be modeled via network propagation from their protein or other target molecules.

Using these methods, an exemplary working drug synergy prediction model (FIG. 13A) was implemented. The implementation was trained and tested on a publicly available drug combination dataset generated by the U.S. National Cancer Institute, comprising more than 5,000 drug pairs tested against 60 well-characterized cancer cell lines. For the cell line molecular features, we obtained mutation (point and indel), copy number alteration, transcriptomic (RNA sequencing), proteomic (reverse phase protein arrays or RPPA), and metabolomic (liquid chromatography-mass spectrometry) data from the Broad Institute's DepMap portal for 47 of the 60 cell lines for which all datasets were available. We extracted relevant cell line-specific features from each dataset and applied scores to these. The specific features were either taken directly from the data sources as presence/absence (e.g., mutations and copy number changes) or as over-or under-expressed molecules with respect to other measured cell lines (protein/phospho-protein expression levels, metabolite abundances) or inferred from the source data (e.g., active transcription factors inferred from target RNA expression measurements). These scores were mapped to matched interactome nodes and used as input to network propagation. The interaction network used the 2020 version of the Reactome Functional Interactome (ReactomeFI), which includes a mixture of undirected and signed and/or directed protein-protein interaction edges. In addition, select protein-metabolite interaction edges derived from the Human Metabolome Database (HMDB) for species present in the metabolomics dataset were included. The individual propagation vectors for each cell line's molecular feature types were then summed node-wise to create a final cell line embedding for input to the model. For the drug features, 2,048-bit Morgan fingerprints were computed from their structural SMILES strings. For each cell line-drug1-drug2 triplet, the cellular feature embedding vector and drug fingerprints vectors were concatenated into a single 18,458 element vector. During model training, feature vectors for the two possible drug orientations (i.e., cell line-drug1-drug2 and cell line-drug2-drug1) were provided to the model to avoid order bias.

A composite score was computed to summarize the multi-dose combination synergies from the screen data for each cell line-drug1-drug2 triplet, specifically the mean excess over Bliss (excess response over the expectation for an additive response). These scores served as the output responses to which the regression model was fit. The available dataset was divided into training, validation, and testing partitions that comprised 60%, 20%, and 20%, respectively. The model structure comprises a series of fully connected neural network layers, with an 18,458 element input layer (i.e., the size of the input vectors), two hidden layers (2,048 and 1,024 nodes, respectively), and a single node output layer with linear activation. The internal hidden layers used rectified linear unit (ReLU) activation functions, and dropout and batch normalization were applied. The model parameters were tuned using the Adam optimization algorithm, minimizing the mean squared error between true and predicted synergy scores. Training was terminated if validation error did not improve for 20 epochs (retaining the last best model) or if a maximum of 500 epochs was reached.

The trained model's performance was interrogated by comparing predicted against actual synergy scores for cell line drug combinations in the held-out test data, i.e., data the model did not see during training (FIG. 13B). A strong Pearson correlation of 0.72 was observed between all (>47,000) real and predicted synergy scores, with some cell line-specific results exceeding 0.82 correlation. The model's performance was also tested as a classifier using receiver operator characteristic (ROC) and precision-recall (P-R) analyses. Here, actual scores greater than 0.05 were classified as synergies, and scores less than −0.05 were classified as antagonisms. The area under the curve (AUC) from the ROC and P-R analyses were 0.94 and 0.88, respectively (FIGS. 13C-13D). With stricter (more stringent) classification thresholds of 0.1 and −0.1, the ROC and P-R AUCs were 0.97 and 0.95, respectively. This performance is highly consistent with existing deep learning-based synergy prediction methods. In addition, some model-predicted synergies were identified among drug pairs where at least one of the agents was not used to train the model that has been validated in targeted screens.

Model predictions may be used to guide and prioritize screen drug selection, focusing particularly on novel drug pairs. Screen data collected from these initial predictions and routine screening may be fed back to the initial model(s) to refine parameters and enhance prediction accuracy. Such iteration may be applied periodically to improve model performance and guide future screens (FIG. 13E).

In addition to these screening goals, the model may be used to infer biological characteristics of combination responses. These may include mechanisms of action or more routine biomarker discoveries. Such inferences may also inform a screening strategy by indicating pathways and/or specific targets critical to combination efficacy and ultimately steer compound class selection. While the neural network framework described here is essentially a black box, i.e., a model in which the internal decision making is not available or easily interpretable, those of skill in the art will understand, upon reading this description, that it is an hypothesis generator from which drug combinations in various tissues can be predicted. From these predictions, specimen molecular readouts, either from direct data or from the input network embeddings, may, e.g., be used to infer which features are associated with synergistic responses. Such techniques are analogous to those commonly implemented for biomarker discovery with empirical data in single-agent or drug combination studies. These predicted biological findings may be further validated with subsequent empirical data collection. In addition, hypothesis generation may not only predict the penultimate set of combinations likely to exhibit synergistic responses but may propose confirmatory experiments focused on the local network neighborhoods of synergy-associated molecules. The results of these proposed experiments may feed back to the machine-learned model itself. In this manner, e.g., a drug synergy prediction model may use machine learning to predict synergy responses from drug combinations and/or generate hypotheses for follow on experiments to enrich the predictive power of the model via additional experimentally-derived data.

### Discussion

Aspects of these inventions instruct a method and apparatus for forming uniform emulsions of immiscible materials of different densities and then delivering these emulsions into isolated nanowells. In addition, aspects hereof instruct the delivery of a combination of materials into the same nano-compartment to create unique material combinations in each compartment. As an example, we describe the collection of small molecule drugs in a combination grid in nanowells. We further show how to deliver live cells into the same nanowells to achieve live cell—high throughput drug screening.

As shown, embodiments hereof can be further used to deliver the content of precisely positioned nanowells to underlying surfaces that come into contact with them. This capability has special utility in pathology, where tissue specimens are collected and studied post-hoc. Such specimens are typically cut into thin slices and stained with antibody-specific reagents to study protein expression across the tissue. In addition, it is of great interest to study tissue-specific RNA profiles of the cells across the specimens. This approach, termed “spatially resolved transcriptomics,” has been the focus of recent research and was recently defined as the “method of the year” by a top-tier publication [Marx, V. Method of the Year: spatially resolved transcriptomics. Nat Methods 18, 9-14 (2021)]. While some spatially-resolved-transcriptomics methods have been developed, they all suffer from low sampling of RNA molecules across the tissue, likely because reverse transcription of RNA is limited by the number of oligonucleotide primers available in each location in the methods developed to date.

The approach described herein enables the loading of nanowells with location-specific DNA barcodes. These barcodes also act as primers for RNA reverse transcription. These primers thus carry nano-compartment-specific location information to the tissue. Since these nanowells have the capacity to house a great density of oligonucleotide primers, they facilitate highly efficient sampling of the underlying RNA, thus solving the problem of limited RNA capture that has been described in existing methods to date.

### CONCLUSION

Where a process is described herein, those of ordinary skill in the art will appreciate that the process may operate without any user intervention. In another embodiment, the process includes some human intervention (e.g., an act is performed by or with the assistance of a human).

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the phrase “using” means “using at least” and is not exclusive. Thus, e.g., the phrase “using x” means “using at least x.” Unless specifically stated by the use of the word “only,” the phrase “using x” does not mean “using only x.”

As used herein, including in the claims, the phrase “based on” means “based in part on” or “based, at least in part, on,” and is not exclusive. Thus, e.g., the phrase “based on factor x” means “based in part on factor x” or “based, at least in part, on factor x.” Unless specifically stated by the use of the word “only,” the phrase “based on x” does not mean “based only on x.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “x is distinct from Y” means that “x is at least partially distinct from Y” and does not mean that “x is fully distinct from Y.” Thus, as used herein, including in the claims, the phrase “x is distinct from Y” means that x differs from Y in at least some way.

It should be appreciated that the words “first,” “second,” and so on, in the

description and claims, are used to distinguish or identify and not to show a serial or numerical limitation. Similarly, letter labels (e.g., “(A),” “(B),” “(C),” and so on, or “(a),” “(b),” and so on) and/or numbers (e.g., “(i),” “(ii),” and so on) are used to assist in readability and to help distinguish and/or identify and are not intended to be otherwise limiting or to impose or imply any serial or numerical limitations or orderings. Similarly, words such as “particular,” “specific,” “certain,” and “given” in the description and claims, if used, are to distinguish or identify and are not intended to be otherwise limiting.

As used herein, including in the claims, the terms “multiple” and “plurality” mean “two or more” and include the case of “two.” Thus, e.g., the phrase “multiple ABCs” means “two or more ABCs” and includes “two ABCs.” Similarly e.g., the phrase “multiple PQRs,” means “two or more PQRs,” and includes “two PQRs.”

The present invention also covers the exact terms, features, values, and ranges, etc. in case these terms, features, values, and ranges, etc. are used in conjunction with terms such as about, around, generally, substantially, essentially, at least, etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

Use of exemplary language, such as “for instance,” “such as,” “for example” (“e.g.,”) and the like, is merely intended to better illustrate the invention and does not indicate a limitation on the scope of the invention unless specifically so claimed. The abbreviation “i.e.” means “that is.”While the invention has been described in connection with what is presently

considered to be the most practical and preferred embodiments, it is to be understood that the invention is not to be limited to the disclosed embodiment but, on the contrary, is intended to cover various modifications and equivalent arrangements included within the spirit and scope of the appended claims.

1. A microfluidic system comprising:
a matrix structure having a plurality of wells,
each of the wells being accessible via at least one microfluidic path connectable via an interface to at least one droplet input for receiving one or more sets of droplets from one or more droplet sources,
wherein a droplet enters a well based on one or more of buoyancy, gravity, hydrodynamic force, and/or mechanical capturing, and
wherein contents of a particular well are determinable based on a position of the particular well in the matrix structure and on inputs to the matrix structure.

2. The microfluidic system of claim 1, wherein the wells are arranged in m columns and n rows, where m and n are positive integers.

3. The microfluidic system of claim 2, wherein m=n.

4. The microfluidic system of claim 2, wherein m≠n.

5. The microfluidic system of claim 2, wherein m is 1 to 1,000 and nis 1 to 1,000.

6. The microfluidic system of claim 2, wherein the columns are evenly spaced, and the rows are evenly spaced.

7. The microfluidic system of claim 2, wherein the columns and/or rows are unevenly spaced.

8. The microfluidic system of claim 1, wherein wells allow controlled releasing of a certain number of droplets from the wells by tilting the matrix structure.

9. The microfluidic system of claim 1 further comprising an area where droplets can flow and get access to the wells.

10. The microfluidic system of claim 9, wherein the area comprises a plain chamber or a chamber with structures.

11. The microfluidic system of claim 10, wherein the structures comprise grooves, channels, and/or posts.

12. The microfluidic system of claim 9, wherein the area comprises the at least one microfluidic path.

13. The microfluidic system of claim 1, wherein one or more droplets rise or sink via buoyancy from the at least one microfluidic path into wells having sufficient space.

14. The microfluidic system of claim 1, wherein the wells are sized to capture and/or hold at least one, at least two, at least three, at least four, at least five, at least six, at least seven, at least eight, at least nine, and/or at least ten droplets.

15. The microfluidic system of claim 1, wherein each of the wells is cylindrical, a cube, cuboid, a dome, triangular, hexagonal, or one or more of these shapes, combined vertically and/or horizontally.

16. The microfluidic system of claim 1, wherein a shape of the wells allows droplets to be released from the wells by flipping or tilting the matrix structure.

17. The microfluidic system of claim 1, wherein a shape of the wells allows release of a selective number of droplets by flipping or tilting the matrix structure.

18. The microfluidic system of claim 2, comprising at least one set of loading channels for providing droplets from the droplet sources to the wells.

19. The microfluidic system of claim 18, wherein the at least one set of loading channels is integrated into the matrix structure.

20. The microfluidic system of claim 18, wherein the at least one set of loading channels is integrated into a loading module, sealably connectable to the matrix structure.

21. The microfluidic system of claim 2, comprising: two sets of loading channels for providing droplets from the droplet sources to the wells.

22. The microfluidic system of claim 21, wherein the two sets of loading channels are integrated into the matrix structure.

23. The microfluidic system of claim 21, wherein the two sets of loading channels comprise:
a first set of p loading channels for the columns; and
a second set q of loading channels for the rows.

24. The microfluidic system of claim 2, wherein there are m columns and m loading channels for the columns.

25. The microfluidic system of claim 2, wherein there are n rows and n loading channels for the rows.

26. The microfluidic system of claim 2, wherein there is a loading channel for each column.

27. The microfluidic system of claim 2, wherein there is a loading channel for each row.

28. The microfluidic system of claim 18, wherein droplets from the droplet sources enter the matrix structure via the loading channels.

29. The microfluidic system of claim 23, wherein the one or more droplet sources comprise:
a first m droplet sources corresponding to the first set of p loading channels; and
a second n droplet sources corresponding to the second set of q loading channels.

30. The microfluidic system of claim 1, wherein the one or more droplet sources provide droplets of reagents.

31. The microfluidic system of claim 1, further comprising a plurality of droplet generators.

32. The microfluidic system of claim 31, wherein the droplet generators generate droplets of volume of at least 1 pL, at least 1 nL, at least 100 nL, at least 1 μL, or at least 10 μL.

33. The microfluidic system of claim 31, wherein at least some of the droplet generators generate continuously emulsifying reagents of volume of at least 1 pL, at least 1 nL, at least 100 nL, at least 1 μL, at least 10 μL, at least 100 μL, at least 1 mL, at least 10 mL, at least 100 mL, or at least 1 L.

34. The microfluidic system of claim 31, wherein the droplet generators are connectable to the matrix structure via tubing.

35. The microfluidic system of claim 31, wherein the droplet generators are integrated into the matrix structure.

36. The microfluidic system of claim 31, wherein the droplet generators operate simultaneously as the matrix structure.

37. The microfluidic system of claim 31, wherein the droplet generators emulsify reagents that are stored and are re-introduced into a matrix structure at a different time.

38. The microfluidic system of claim 37, wherein emulsified reagents are stored in one or more containers.

39. The microfluidic system of claim 38, wherein the one or more containers comprise one or more of: tubing, tubes, a multiwell plate, and/or a matrix plate, alone or in combination.

40. The microfluidic system of claim 1, wherein the one or more sets of droplets comprise one or more reagents selected from: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

41. The microfluidic system of claim 40, wherein the one or more sets of droplets comprise one or more drugs, and wherein the one or more drugs were selected using a drug synergy prediction model.

42. The microfluidic system of claim 41, wherein the drug synergy prediction model uses machine learning to predict synergy responses from drug combinations.

43. The microfluidic system of claim 41, wherein the drug synergy prediction model uses machine learning to predict synergy responses from drug combinations and/or to generate hypotheses for follow on experiments.

44. A method comprising:
(A) providing first droplets into a plurality of wells via one or more paths of a matrix structure, and wherein the first droplets enter the plurality of wells via the one or more paths by buoyancy, gravity, hydrodynamic force, and/or mechanical capturing; and
(B) providing second droplets into at least some of the plurality of wells, by buoyancy, gravity, hydrodynamic force, and/or mechanical capturing, wherein at least some of the wells contain a combination of a droplet from the first droplets and a droplet from the second droplets, wherein
each combination of droplets is spatially identifiable by position in the matrix structure.

45. The method of claim 44, wherein the first droplets comprise emulsified reagents selected from: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

46. The method of claim 44, wherein the first droplets comprise one or more drugs, and wherein the one or more drugs were selected using a drug synergy prediction model.

47. The method of claim 46, wherein the drug synergy prediction model uses machine learning to predict synergy responses from drug combinations.

48. The method of claim 46, wherein the drug synergy prediction model uses machine learning to predict synergy responses from drug combinations and/or to generate hypotheses for follow on experiments.

49. The method of claim 44, further comprising:
(C) merging each combination of droplets in the wells.

50. The method of claim 49, wherein the merging in (C) comprises applying an electric field, acoustic wave, heat, mechanical force, or chemical reagents.

51. The method of claim 49, wherein one or more additional droplets comprising reagents are added into at least some of the plurality of wells prior to the merging in (C).

52. The method of claim 51, wherein the one or more additional droplets comprise emulsified reagents selected from: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

53. The method of claim 51, wherein the one or more additional droplets comprise one or more drugs selected using a drug synergy prediction model.

54. The method of claim 53, wherein the drug synergy prediction model uses machine learning to predict synergy responses from drug combinations.

55. The method of claim 53, wherein the drug synergy prediction model uses machine learning to predict synergy responses from drug combinations and/or to generate hypotheses for follow on experiments.

56. The method of claim 44, wherein the wells are arranged in rows and columns, and wherein the one or more paths comprise one or more channels aligned with the columns.

57. The method of claim 56, wherein there is one channel per column.

58. The method of claim 56, wherein there are n columns, and wherein the one or more paths comprise n paths.

59. The method of claim 56, wherein the one or more paths comprise one or more common reservoirs being fed into the columns.

60. The method of claim 59, wherein the one or more common reservoirs consist of a single reservoir.

61. The method of claim 44, wherein the wells are arranged in m rows and n columns, and wherein the first droplets are provided using m first droplet sources, each arranged to provide droplets to a corresponding row of wells.

62. The method of claim 61, wherein the second droplets are provided using n second droplet sources, each arranged to provide droplets to a corresponding column of wells.

63. The method of claim 62, wherein each of the m first droplet sources provides a first different type of droplet to the corresponding rows, and wherein each of the n second droplet sources provides a second different type of droplet to the corresponding columns.

64. The method of claim 62, wherein the m first droplet sources provide m first distinct types of droplets, and wherein the n second droplet sources provide n second distinct types of droplets.

65. The method of claim 62, wherein, a particular well at column i, and row j in the matrix, for 1≤i≤m, and 1≤j≤n, contains a particular combination of a first droplet from the i-th first droplet source and a second droplet from the j-the second droplet source.

66. The method of claim 44, further comprising:
before beginning the providing in (B), continuing the providing in (A) until each well of the matrix structure contains at least one of the first droplets.

67. The method of claim 44, manipulating the matrix structure to selectively release droplets from the wells.

68. The method of claim 44, wherein the providing in (B) begins after each well of the matrix structure has one of the first droplets.

69. The method of claim 44, further comprising:
(D) providing third droplets into at least some the plurality of wells, by buoyancy, gravity, hydrodynamic force, and/or mechanical capturing, wherein at least some of the wells contain a combination of a droplet from the first droplets and a droplet from the second droplets and a droplet from the third droplets.

70. The method of claim 44, wherein the first droplets comprise a first set of drugs and wherein the second droplets comprise a second set of drugs, the method further comprising:
(E) introducing a live cell into each of the wells, wherein each well contains a combination of a first drug from the first set of drugs, a second drug from the second set of drugs, and a live cell.

71. The method of claim 70, wherein the first set of drugs is identical to the second set of drugs.

72. The method of claim 70, where droplets are introduced into the wells in an order (i) drug, drug cell; or (ii) cell, drug, drug, or (iii) drug, cell, drug.

73. The method of claim 70, wherein at least some of the first set of drugs and at least some of the second set of drugs were selected using a drug synergy prediction model.

74. The method of claim 73, wherein the drug synergy prediction model uses machine learning to predict synergy responses from drug combinations.

75. The method of claim 73, wherein the drug synergy prediction model uses machine learning to predict synergy responses from drug combinations and/or to generate hypotheses for follow on experiments.

76. The method of claim 44, wherein the providing in (A) uses oil to connect the wells.

77. The method of claim 76, further comprising: replacing the oil with air or some other gas.

78. The method of claim 44, further comprising: quantifying effect of combinations of drugs in the wells.

79. The method of claim 78, wherein the quantifying uses imaging of the wells.

80. The method of claim 79, further comprising selectively retrieving content from wells of interest after imaging.

81. A method comprising:
(A) providing a plate comprising a matrix structure having a plurality of wells, each of the wells being accessible via at least one microfluidic path connectable via an interface to at least one droplet input for receiving one or more sets of droplets from one or more droplet sources, wherein the wells are arranged in m columns and n rows, where m and n are positive integers; and
(B) populating each particular well of at least some of the wells with a droplet comprising well-location information to determine a location of the well in the matrix structure.

82. The method of claim 81, wherein the well-location information in the droplet for a given well comprises (i) a column oligo barcode that identifies which column of the matrix structure the given well is in; and (ii) a row oligo barcode that identifies which row of the matrix structure the given well is in.

83. The method of claim 81, wherein the populating in (B) comprises:
(B)(1) populating wells in the matrix structure with column droplets comprising column oligo barcodes that identify which column of the matrix structure a well is in; and
(B)(2) populating wells in the matrix structure with row droplets row oligo barcodes that identify which row of the matrix structure a well is in.

84. The method of claim 83, wherein the populating in (B) further comprises:
(B)(3) populating wells in the matrix structure with reagent droplets comprising at least one reagent.

85. The method of claim 84, further comprising, in wells containing a column droplet, a row droplet, and a reagent droplet, merging the column droplet and the row droplet and the reagent droplet to form the droplet comprising well-location information.

86. The method of claim 84, wherein the reagent droplets comprise one or more reagents selected from: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

87. The method of claim 81, further comprising:
sealing the matrix structure.

88. The method of claim 81, further comprising:
freezing the matrix structure.

89. The method of claim 81, wherein m is 1 to 1,000 and nis 1 to 1,000.

90. The method of claim 81, where the matrix structure is about p mm x q mm, where p is in the range 1 to 100 and q is in the range 1 to 100.

91. The method of claim 81, wherein the matrix structure has a well density of about 1 well per 100 um² to 1 well per mm².

92. The method of claim 81, wherein the matrix structure has a well density of about 1000/mm² or about 100/mm² or about 10/mm².

93. The method of claim 81, wherein the columns are evenly spaced, and the rows are evenly spaced.

94. The method of claim 84, wherein the at least one reagent is selected from: one or more drugs, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

95. A plate comprising:
a matrix structure having a plurality of wells, each of the wells being accessible via at least one microfluidic path connectable via an interface to at least one droplet input for receiving one or more sets of droplets from one or more droplet sources, wherein the wells are arranged in m columns and n rows, where m and n are positive integers,
wherein each particular well of at least some of the wells is populated with a droplet comprising well-location information to determine a location of the well in the matrix structure.

96. The plate of claim 95, wherein the well-location information in the droplet for a given well comprises (i) a column oligo barcode that identifies which column of the matrix structure the given well is in; and (ii) a row oligo barcode that identifies which row of the matrix structure the given well is in.

97. The plate of claim 95, where the droplets in the wells in the matrix structure also comprise at least one reagent.

98. The plate of claim 97, wherein the at least one reagent includes one or more of: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

99. The plate of claim 95, wherein the plate has a well density of about 1 well per 100 um² to 1 well per mm².

100. The plate of claim 95, wherein the plate is about p mm×q mm, where p is in the range 1 to 100 and q is in the range 1 to 100.

101. The plate of claim 95, wherein the plate has between 10 and 10,000 wells, more preferably between 500 and 5000 wells.

102. The plate of claim 95, wherein a well diameter of a well is about 10 microns, to about 100 microns, preferably about 10 microns.

103. A plate formed by the method of claim 81.

104. A method comprising:
(A) pressing a matrix plate against a tissue specimen on a slide, wherein the matrix plate comprises a plurality of wells, each populated with a droplet comprising well-location information to determine a location of the well in the matrix plate, wherein said pressing causes at least one reagent from each of the wells to come in contact with the tissue specimen;
(B) imaging the matrix plate pressed against the tissue specimen;
(C) collecting content from the wells;
(D) sequencing the collected content; and
(E) using the sequenced collected content to provide an RNA profile of the tissue specimen by location.

105. The method of claim 104, further comprising, before the collecting in (C),
combining the contents of the wells with the tissue specimen.

106. The method of claim 105, wherein the combining comprises:
centrifuging the matrix plate pressed against the tissue specimen; and then
flipping the matrix plate and then again centrifuging the matrix plate pressed against the tissue specimen.

107. The method of claim 104, wherein the matrix plate is clamped to the slide.

108. The method of claim 10, wherein the at least one reagent includes one or more of: one or more drugs, one or more oligonucleotide, one or more cells, a cluster of cells, an organoid, a tissue sample, one or more dyes, one or more proteins, one or more enzymes, one or more buffers, one or more oligonucleotides, one or more antibodies, dNTPs, reverse transcriptase, and/or lyophilized materials.

109. The method of claim 10, wherein, prior to said collecting in (C), said at least one reagent from at least some of the wells comes in contact with and then binds to proteins and/or RNA and/or DNA in the tissue specimen.

110. The method of claim 10, wherein reagents from at least some of the wells come into contact with the tissue specimen and trigger enzymatic reactions.

111. The method of claim 110, wherein the enzymatic reactions comprise reverse transcription of RNA of the tissue specimen and/or copying of DNA of the tissue specimen.

112. The method of claim 10, wherein proteins or nucleic acids from the tissue specimen are collected into the wells.

113. The method of claim 112, wherein the nucleic acids comprise RNA and/or DNA.

114. The method of claim 112, wherein enzymatic reactions between said proteins or nucleic acids from the tissue specimen and the at least one reagent occur in at least some of the wells.

115. The method of claim 104, wherein one or more chemical reactions occur in the wells between the tissue specimen in the wells and content of the wells.

116. The method of claim 115, wherein the one or more chemical reactions comprise:
reverse transcription of RNA of the tissue specimen; and/or
PCR amplification of DNA of the tissue specimen; and/or
binding of antibodies to proteins of the tissue specimen.
